(19) United States
(12) Patent Application Publication
(10) Pub. No.: US 2016/0286600 A1
(43) Pub. Date: Sep. 29, 2016

(54) MULTIPLE CONCURRENT CONTEXTS VIRTUAL EVOLVED SESSION MANAGEMENT (VIRTUAL ESM)

(71) Applicant: QUALCOMM Incorporated, San Diego, CA (US)

(72) Inventors: Stefano Faccin, Hayward, CA (US); Gavin Bernard Horn, La Jolla, CA (US); Soo Bum Lee, San Diego, CA (US); Keiichi Kubota, Farnborough (UK)

(21) Appl. No.: 14/865,364

(22) Filed: Sep. 25, 2015

Related U.S. Application Data
(60) Provisional application No. 62/138,873, filed on Mar. 26, 2015.

(51) Int. Cl. H04W 76/04; H04L 29/06; H04B 1/3816; H04W 48/16; H04W 48/18

(52) U.S. Cl. CPC H04W 76/046; H04W 48/16; H04W 48/18; H04B 1/3816; H04L 63/10; H04L 63/0876

(57) ABSTRACT

According to one aspect, a method includes obtaining, at a device, a plurality of contexts with a plurality of serving nodes. Each of the plurality of contexts may be associated with a context-unique identifier. Each context-unique identifier may uniquely identify one context in the plurality of contexts and be associated with data corresponding to a respective context. The data may be sent via the plurality of contexts via a radio link shared by the plurality of contexts. According to another aspect, a method includes associating each of the plurality of contexts with a separate set of credentials. Each set of credentials uniquely identifies one context and may be associated with data corresponding to a respective context. The data corresponding to a respective context may be encrypted based on the set of credentials associated with the context and sent via a radio link shared by the plurality of contexts.

This application claims priority to U.S. Provisional Application No. 62/138,873, filed Mar. 26, 2015, titled Multiple Concurrent Contexts Virtual Evolved Packet System Management (Virtual ESM), the contents of which are incorporated by reference herein.

### FIELD

The present application is related to the use of multiple concurrent non-access stratum (NAS) contexts established between a single physical device (e.g., chip component or client device) and multiple serving nodes (e.g., mobility management entity (MME) devices).

### BACKGROUND

Presently, a single device (e.g., a chip component or a client device) establishes a single NAS context with a single mobility management entity (MME). Preceding establishment of the NAS context, the device performs a radio resource control (RRC) connection procedure with an access node. Once the RRC connection procedure is completed, the device sends an RRC Connection Setup Complete message to the access node. A parameter known as “Dedicated Info NAS” is used to transfer NAS layer information between the device and the MME in a network. The Dedicated Info NAS is specific to the device sending the information. Although the Dedicated Info NAS information is sent in the RRC layer, the RRC is transparent for this information. The RRC layer is only used to transport this information. The RRC Connection Setup Complete message may also carry octets for one NAS message exchanged between the device and the MME. Only one MME is coupled to a device at a given time.

In the past, 3G systems supported a single subscription/single credential that operated a pair of connections between a single client device (e.g., mobile device, user device, user equipment, terminal) and two services (e.g., a data service and a voice service), but the pair of connections existed in a corresponding pair of domains. The domains were the packet switched domain and circuit switched domain. Typically, data services were handled in the packet switched domain, while voice services were handled in the circuit switched domain. In the packet switched domain, data is conveyed in discrete groups referred to as packets. Packets may be conveyed from a source to a destination via any number of routes/circuits. In the circuit switched domain, signals are conveyed from source to destination via one dedicated route/circuit that needed to be maintained for the entire duration of the connection. An example of a circuit switched domain is the public switched telephone network (PSTN).

The 3G systems supported an ability of a client device to register for the two domains using a single subscription/credential in a single procedure. According to that procedure, an uplink dedicated control channel (UL DCCH) message was used to carry registrations for the circuit switched and the packet switched domains. A serving general packet radio service (GPRS) support node (SGSN) in the packet switched domain would update a mobile switching center (MSC) in the circuit switched domain. In this way, 3G systems allowed for communication in two distinct domains using a single subscription/single credential. Even so, within each distinct domain there existed only a single context for the single subscription/credential on a single radio link. In other words, a client device in a 3G system had one context (e.g., NAS context), it utilized the one context in connection with its subscription/credential in the packet switched domain and utilized the same context in connection with the same subscription/credential in the circuit switched domain. However, wireless system standards of today (e.g., current standards such as 4G, LTE, LTE-A, WLAN, Wi-Fi) operate only in the packet switched domain. Furthermore the wireless systems of today still support only a single subscription/single credential using a single context (e.g., NAS context) between a client device and a connectivity management portion of a network (e.g., the mobility management entity (MME)). Moreover, today's wireless systems support use of only one MME per connectivity context.

Today, client devices include a subscriber identity module (SIM) card that includes identification information and a key unique to that SIM card. These may effectively be considered as the credentials of a client device. A client device making use of a subscription to a service provided by a network operator is able to establish a radio link with a single NAS context with the network using the identification and key information stored on the SIM card as its credentials.

If a user needs to use one credential for business applications and a second credential for personal applications, the limitation of the use of only one MME per NAS context per radio link will force a user to obtain a second device, or a different SIM card for the device already owned. Even devices that have two SIM cards do not offer the ability to support the credentials of both SIM cards concurrently (i.e., do not support concurrent multiple NAS contexts) on a single radio link.

What is needed are methods, devices, and/or systems to break the paradigm of a single device, single NAS context, single MME to device coupling and/or to overcome any or all of the above-mentioned drawbacks of the prior art.

### SUMMARY

According to one aspect, a method may include obtaining, at a device, a plurality of contexts with a plurality of serving nodes. Each of the plurality of contexts may be associated with a context-unique identifier Each context-unique identifier may uniquely identify one context in the plurality of contexts. Each context-unique identifier may be associated with data corresponding to a respective context. The data may be sent via the plurality of contexts via a radio link shared by the plurality of contexts. According to one aspect, the plurality of serving nodes may be comprised of a plurality of logical instances of one or more physical serving node. As presented herein, each context may correspond to a service. Each context may be associated with a plurality of subscriptions. The device may be associated with a plurality of credentials and each context may be associated with a separate one of the plurality of credentials. In other words, the plurality of contexts may be associated with a plurality of credentials. At least one of the plurality of contexts may correspond to a set of subscriber credentials, which is a default set of subscriber credentials. The plurality of contexts may be a plurality of non-access stratum (NAS) contexts. The plurality of serving nodes may be a plurality of mobility management entities (MMEs), which may be independent of each other.

According to some aspects, each context-unique identifier may be derived by the device. According to other aspects, the context-unique identifier may include a portion derived by the device and a portion corresponding to an identifier of the device. The identifier of the device may be one of a globally unique temporary identifier (GUTI), a radio network temporary identifier (RNTI), and/or an identifier allocated by a network to the device related to a location of the device.

The device may obtains each context-unique identifier from an access node. Each context-unique identifier may include a portion derived by the access node and a portion corresponding to an identifier of the device.

The data may be control-plane data or user-plane data. The data may be encrypted with credentials associated with the context-unique identifier associated with the data. Distinct security contexts may be associated with each of the plurality of contexts.

The radio link may be served by an access node, shared by the plurality of contexts, and concurrently serve one or more radio resource control (RRC) connections. Data associated with the plurality of contexts may be multiplexed over the radio link over one RRC connection.

According to some aspects, each of the plurality of contexts can be set to one of a plurality of modes independent of other contexts in the plurality of contexts. Each mode may describe a status of an RRC connection. A handover, from a first access node to a second access node, transferring, by the device, each of the plurality of contexts that are served by the first access node, may transfer only those contexts that are in a connected mode and not in an idle mode from the first access node to the second access node. The plurality of contexts may be associated with a respective plurality of tracking areas within a plurality of cells in a network. A first tracking area associated with a first context may be different from a second tracking area associated with a second context.

According to another aspect, a plurality of contexts may be associated with a plurality of serving nodes. Each of the plurality of contexts may be associated with a separate set of credentials. Each set of credentials may uniquely identify one context in the plurality of contexts and be associated with data corresponding to a respective context. The data corresponding to a respective context may be encrypted based on the set of credentials associated with the context. The data may then be sent via a radio link shared by the plurality of contexts.

According to another aspect, a first radio resource control (RRC) connection at an access node may be established by a device. The device may initiate transport of a first non-access stratum (NAS) message over the first RRC connection to a first mobility management entity (MME). The device may establish a first NAS context between the device and the first MME. A second RRC connection at the access node may be established by the device, where the first RRC connection is different from the second RRC connection. The device may initiate transport of a second NAS message over the second RRC connection to a second MME, wherein the first MME is different from the second MME. A second NAS context may be established between the device and the second MME. The first NAS context and the second NAS context between the device and the first MME and second MME may be concurrently operated.

According to another aspect, a first radio resource control (RRC) connection at an access node may be established by a device. The device may initiate transport of a first non-access stratum (NAS) message over the first RRC connection to a first mobility management entity (MME). A first NAS context between the device and the first MME may be established. The device may initiate transport of a second NAS message over the first RRC connection to a second MME. The first MME may be different from the second MME. A second NAS context between the device and the second MME may be established. The first NAS context and the second NAS context between the device and the first MME and second MME may be concurrently operated.

According to another aspect, a first radio resource control (RRC) connection may be established by a device. A plurality of multiplexed non-access stratum (NAS) messages may be sent over the first RRC connection to a corresponding plurality of mobility management entities (MMEs). A plurality of non-access stratum (NAS) contexts may be established between the device and the plurality of MMEs. The plurality of NAS contexts between the device and the plurality of MMEs may be concurrently operated.

According to another aspect a method operational at an access node may include receiving data over a radio link shared by a plurality of contexts from a device. The data may be associated with a first context-unique identifier that uniquely identifies only one context in the plurality of contexts. Mobility management entity (MME) selection to route the data based on the first context-unique identifier may be performed. The plurality of contexts may be a plurality of non-access stratum (NAS) contexts. The radio link shared by the plurality of contexts may concurrently serve one or more radio resource control (RRC) connections. Performing MME selection may occur even if a radio access network (RAN) is already handling a context associated with the device and identified by a second context-unique identifier, where the first and second context-unique identifiers are different. Performing mobility management entity (MME) selection based on the first context-unique identifier may include performing a search for the first context-unique identifier in a table stored at the access node. The table may provide a cross-reference between context-unique identifiers and MME identifiers. The MME may be selected based on a result of performing the search. The data may be sent to the selected MME. The method may further include receiving first data associated with a first context and the first context-unique identifier over the radio link, and receiving second data associated with a second context and a second context-unique identifier over the radio link. The first data and the second data may be destined for different contexts established for the device, and the different contexts established for the device may operate concurrently. Distinct security contexts may be associated with the first context and the second context. The first data and the second data may be forwarded from a packet data convergence protocol (PDCP) entity of a communication protocol stack. The first data and the second data may be multiplexed on one RRC connection via the radio link.

According to one aspect, the method may also include receiving a first set of keys associated with the first data and a second set of keys associated with the second data. Integrity protection and ciphering may be implemented on the first data using the first set of keys and on the second data using the second set of keys.

According to one aspect, the method may include mapping device identifiers to context identifiers, mapping context identifiers to MME identifiers, mapping context identifiers to security contexts, mapping context identifiers to serving gateways, and storing mapping results in a memory device at the access node.

The method may further include receiving additional data over the radio link from the device. The additional data may be associated with multiple concurrent contexts multiplexed together on one RRC connection over the radio link, and the additional data appears to the access node as data from a set of devices, each of the set of devices associated with a specific subscription credential that is different from subscription credentials of other devices.

According to another aspect, a method operational at a serving gateway may include sending a data notification to a mobility management entity (MME) to initiate a paging procedure for a first context of a device having a plurality of contexts, the data notification including a device identifier of the device and a first context identifier of the first context. The method may further include providing the MME with an access node identifier, where the access node identifier identifies an access node on which a second context of the plurality of contexts is camped. Providing the MME with the access node identifier may include instructing an access node associated with the device to send the access node identifier to the MME. Providing the MME with the access node identifier may include sending the access node identifier to the MME directly from the serving gateway. According to one aspect, the second context may be different from the first context. The second context may be in an active mode while the first context is simultaneously in an idle mode. The data notification sent by the serving gateway may be used to trigger the first context identified by the first context identifier to send a service request, including the device identifier and the first context identifier, to the access node over a radio link of a radio access network. The device identifier may be a globally unique temporary UE identity (GUTI). According to some aspects, the first context monitors paging channels while in an idle mode even when another context in the plurality of contexts is in an active mode.

### DRAWINGS

FIG. 1 illustrates a single radio link between a client device and two networks where the client device, in accordance with aspects described herein, is split into multiple logical contexts, each context served by a different mobility management entity.

FIG. 2 is a block level diagram illustrating concurrent connectivity of two logical instances of a client device with two MMEs, MME A and MME B, via one radio resource control (RRC) connection in accordance with aspects described herein.

FIG. 3 is a flow diagram of a method in accordance with an aspect described herein.

FIG. 4 is an exemplary architectural model of a system making use of virtual ESM tags to distinguish between NAS contexts flowing over a single RRC connection to a plurality of MMEs in accordance with aspects described herein.

FIG. 5 is an exemplary block diagram of signal radio bearer (SRB) and data radio bearer (DRB) security model for use with multiple SRBs, including a new layer of protection for NAS in accordance with aspects described herein.

FIG. 6 is an exemplary flow diagram illustrating a first initial NAS context establishment with a first MME and a subsequent initial NAS context establishment with a second MME in accordance with aspects described herein.

FIG. 7 is an exemplary flow diagram illustrating an initial NAS context establishment between a device (e.g., chip component, client device) and both a first MME and a second MME in accordance with aspects described herein.

FIG. 8 is an exemplary flow diagram illustrating an initial NAS context establishment in a scenario of simultaneous NAS signaling in accordance with aspects described herein.

FIG. 9 is an exemplary flow diagram illustrating a basic case of a handover in which two logical instances of a client device are in an active (connected) mode while a third logical instance of the client device is in an inactive (idle) mode, in accordance with aspects described herein.

FIG. 10 illustrates an exemplary device (e.g., chip component, client device) configured to support multiple connections and credential sets and support concurrent operation of multiple NAS contexts with multiple MMEs, in accordance with aspects described herein.

FIG. 11 is a block diagram illustrating an exemplary method supporting multiple concurrent contexts between a device (e.g., a chip component, client device) and a plurality of serving nodes (e.g., MMEs) over the same radio link in accordance with aspects described herein.

FIG. 12 is a block diagram illustrating another exemplary method supporting multiple concurrent contexts between a device (e.g., a chip component, client device) and a plurality of serving nodes (e.g., MMEs) over the same radio link in accordance with aspects described herein.

FIG. 13 is a block diagram illustrating another exemplary method supporting multiple concurrent contexts between a device (e.g., a chip component, client device) and a plurality of serving nodes (e.g., MMEs) over the same radio link in accordance with aspects described herein.

FIG. 14 is a block diagram illustrating another exemplary method supporting multiple concurrent contexts between a device (e.g., a chip component, client device) and a plurality of serving nodes (e.g., MMEs) over the same radio link in accordance with aspects described herein.

FIG. 15 is a block diagram illustrating another exemplary method supporting multiple concurrent contexts between a device (e.g., a chip component, client device) and a plurality of serving nodes (e.g., MMEs) over the same radio link in accordance with another aspect described herein.

FIG. 16 illustrates an exemplary serving node, an access node, MME, or S-GW configured to support a device in operating on a single radio link shared by multiple logical contexts established for the device in accordance with aspects described herein.

FIG. 17 illustrates a first method of supporting concurrent contexts for the same device according to aspects described herein.

FIG. 18 illustrates a second method of supporting concurrent contexts for the same device according to aspects described herein.

FIG. 19 illustrates another method of supporting concurrent contexts for the same device according to aspects described herein.

### DETAILED DESCRIPTION

In the following description, specific details are given to provide a thorough understanding of the aspects described herein. However, it will be understood by one of ordinary skill in the art that the aspects may be practiced without these specific details. For example, circuits may be shown in block diagrams in order avoid obscuring aspects in unnecessary detail. In other instances, well-known circuits, structures, and techniques may not be shown in detail in order not to obscure the aspects more fully described herein.

The term “exemplary” is used herein to mean “serving as an example, instance, or illustration.” Any implementation or aspect described herein as “exemplary” is not necessarily to be construed as preferred or advantageous over other implementations or aspects. The term “aspect” does not require that all aspects include the discussed aspect, or any discussed feature, advantage, and/or mode of operation. The term “device” may be used herein to refer to a chip component and/or a client device, such as a mobile device, mobile phone, mobile communication devices, mobile computing device, digital tablet, smart phone, user equipment, user device, terminal among other devices. The term “obtain” is used herein to mean derive locally or receive from a non-local source or entity.

For ease of discussion and illustration, the terminology used herein may appear to address LTE; however, the aspects described herein are not intended to be limited to LTE. The aspects described herein are applicable to LTE and beyond LTE, for example 5G. The aspects described herein may also be applicable to networks developed prior to LTE, such as 4G or Wi-Fi. In fact, the aspects described herein may be employed in today's systems, i.e., systems implemented before standardization of 5G. For example, aspects described herein may be introduced as an addendum to the standards of 4G, LTE, and/or LIE-A networks. Accordingly, references made to terms that may be associated with 3G, 4G, and/or LTE-A are made only for illustrative purposes and are not intended to limit the scope of any aspect presented herein.

### Overview

Aspects described herein may support multiple contexts (e.g., NAS contexts) between a single device and multiple mobility management entities (MMEs) (e.g., serving nodes) in a network. Each context may correspond to a different subscription/credential held by the same device. The multiple NAS contexts may be served concurrently on a single radio link. Aspects presented herein may provide for achieving multiple contexts by multiplexing the multiple NAS context messages associated with the multiple contexts over a Layer 2 connection of a communication protocol stack (e.g., LTE Layer 2). Aspects presented herein may provide for achieving multiple contexts by multiplexing the multiple NAS context messages associated with the multiple contexts on one or more RRC connections in an RRC layer of a communication protocol stack.

A physical device may be split into a plurality of logical instances of itself. Each logical instance may have its own credential. Each logical instance may correspond to a specific service. The specific service may be one in which a user has a subscription (e.g., pays a periodic fee to a provider for rights to access and use the service). One MME in a plurality of MMEs may be designated to support the specific service.

Unique identifiers may be derived to identify each of the plurality of logical instances of the device within the device. The unique identifiers may be unique within a given device, but not unique with respect to other devices.

To enable identification of one logical instance of a device from another logical instance of another device, a context-unique identifier may be created. The context-unique identifier may be a combination of the unique identifier derived for the logical instance of the device and a physical address/identifier of the device. The context-unique identifiers may be referred to herein as context-unique identifiers or virtual evolved session management (VESM) tags (i.e., VESM tags). The context-unique identifiers may identify context locally within a radio access network (RAN). The physical address/identifier of the device may be, for example, a global unique temporary identifier (GUTI), a radio network temporary identifier (e.g., an identifier of an RRC connection that is dedicated to the device, such as a cell radio network temporary identifier (C-RNTI)), or an identifier allocated by a network to the device related to the device location.

A given device can establish a radio resource control (RRC) connection with an access node. Each logical instance of the device can establish an NAS context with a dedicated MME. Accordingly, each device may have a plurality of NAS contexts corresponding to a plurality of dedicated MMEs. The access node may maintain a table to cross-reference the context-unique identifiers or VESM tags of each device to their respective dedicated MMEs.

Data for an NAS message exchanged between the device and one of the dedicated MMEs may be multiplexed with data for another NAS message exchanged between the device and another MME. This multiplexed data may be sent in a single RRC connection setup complete message on a single radio link from the device to an access node. To ensure that each NAS message is transmitted to the correct MME, the context-unique identifier associated with an NAS context of a given instance of a device may be appended to the NAS message associated with that instance of the device. The access node may be configured to de-multiplex the various NAS messages from an RRC message and send the de-multiplexed NAS messages to the appropriate MMEs.

### Operational Environment

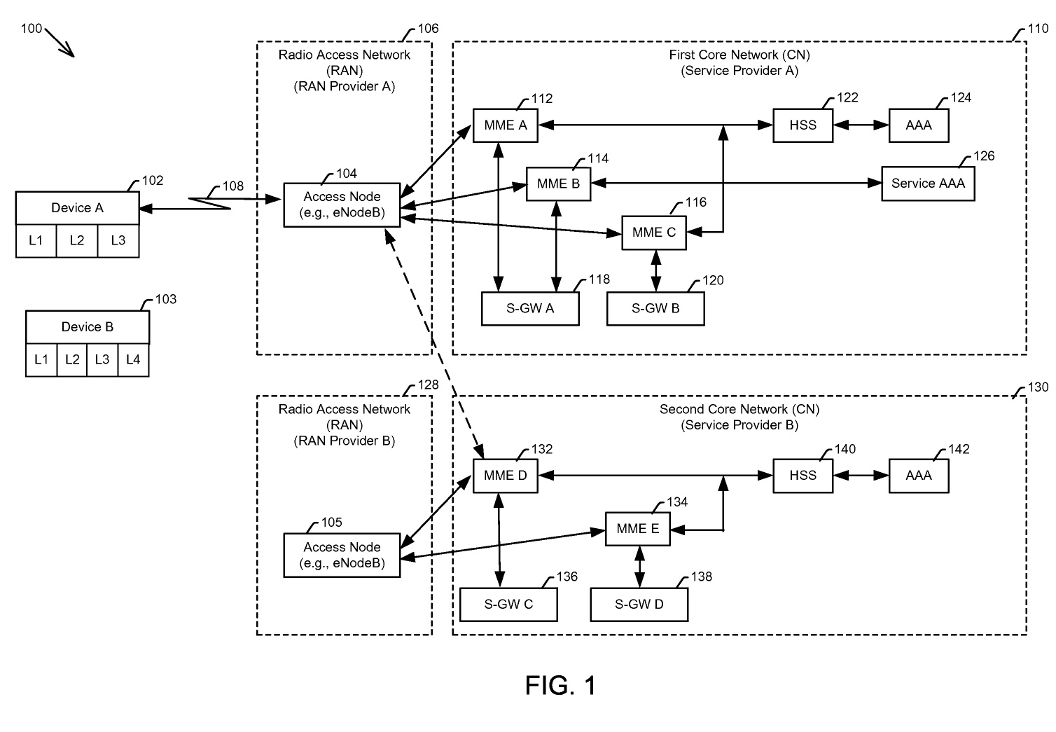

FIG. 1 illustrates a single radio link 108 between a client device and two networks where the client device, in accordance with aspects described herein, is split into multiple logical contexts, each context served by a different mobility management entity. Devices 102, 103 (e.g., chip components, client devices) may communicate with various core networks 110, 130 via various access nodes 104, 105. Each device 102, 103 may be split into multiple logical instances of itself. Device A 102, for example, is split into logical devices L1, L2, and L3. Device B 103, for example, is split into logical devices L1, L2, L3, and L4.

In the exemplary operating environment 100 of FIG. 1, the device 102 (e.g., each of its logical instances L1, L2, and L3) may communicate wirelessly via the single radio link 108 with an access node 104 (e.g., eNodeB, access point (AP)). The access node 104 may be included within a radio access network (RAN) 106 (e.g., evolved universal terrestrial radio access network (E-UTRAN)). As known to those of skill in the art, the RAN 106 typically includes more than one access node 104. Only one access node 104 is illustrated in the RAN 106 to reduce clutter in the drawing.

The single radio link 108 may be established between the client device 102 and the access node 104 of the RAN 106. The single radio link 108 may exist as a physical channel. In terms of the Physical Layer 1 LTE protocol stack, the physical layer carries information from medium access control (MAC) transport channels over the air-interface between the client device 102 and the access node 104.

Within the protocol layers of an E-UTRAN, there exists a radio resource control (RRC) layer. The RRC layer handles broadcasted system information related to the access stratum and transport of non-access stratum (NAS) messages, paging, establishment and release of RRC connections, security key management, handover, client device measurements related to inter-system (inter radio access technology (inter-RAT)) mobility, quality of service (QoS), etc. In the illustration of FIG. 1, a single RRC connection is understood to be encompassed within the single radio link 108 between the client device 102 and the access node 104. This depiction is illustrative and non-limiting. In some aspects described herein, more than one RRC connection may be encompassed within the single radio link 108 between the client device 102 and the access node 104.

In a non-limiting example of a cellular communication system (e.g., 4G, LTE, LTE-A) the RAN 106 may communicate control signals and user data traffic to a first core network (CN) 110 (e.g., evolved packet core (EPC)). Control signals are conveyed via a control plane. User data traffic is conveyed via a user plane.

In accordance with aspects described herein, the first CN 110 may include a plurality of mobility management entity (MME) devices. Three MME devices, MME A 112, MME B 114, and MME C 116 are illustrated in the first CN 110. While each of MME A 112, MME B 114, and MME C 116 are depicted as existing physically separate from one another, one or more mobility management entities may logically exist in one physical mobility management entity device.

Each mobility management entity, MME A 112, MME B 114, and MME C 116 may be coupled to a serving gateway (S-GW) device. In the illustration of FIG. 1, MME A 112 and MME B 114 are both coupled to S-GW A 118 while MME C 116 is coupled to S-GW B 120.

A home subscriber server (HSS) may be coupled to one or more of the mobility management entities. In the illustration of FIG. 1, HSS 122 is coupled to MME A 112 and MME C 116. The HSS 122 may maintain use subscription information. For purposes that include determining an identity and privileges of a user, and for tracking the activities of the user, an authentication, authorization, and accounting (AAA) server, AAA server 124 may be coupled to the HSS 122. A service AAA server 126 is shown as being coupled to MME B 114. The functions of the AAA server 124 and service AAA server 126 may be the same. In some aspects, an operator may deploy the AAA sever (e.g., AAA server 124), while the operator or another party may deploy the service AAA server (e.g., service AAA server 126). Both the AAA server 124 and the service AAA server 126 may be used to store credentials used in aspects described herein. The difference between the two servers may depend on what entity is deploying the credentials and what entity is hosting the AAA. Accordingly, in some aspects such as that shown in FIG. 1, one operator (e.g., Service Provider A in the first CN 110) may deploy both the AAA server 124 and the service AAA server 126. In an alternative aspect, the service AAA server 126 could be hosted by a third party.

A second RAN 128 and a second core network (CN) 130 are depicted in FIG. 1. The second RAN 128 includes access node 105 (e.g., evolved universal terrestrial radio access network (E-UTRAN)). As known to those of skill in the art, the second RAN 128 typically includes more than one access node 105. Only one access node 105 is illustrated in the second RAN 128 to reduce clutter in the drawing. The second CN 130 includes two MMEs, MME D 132 and MME E 134. MME D 132 is coupled to S-GW C 1136 while MME E 134 is coupled to S-GW D 138. An HSS 140 is coupled to MME D 132 and MME E 134. The HSS 140 may maintain user subscription information for users in its home network. A AAA server 142 may be coupled to the HSS 140.

RAN sharing may be implemented, such that MME D 132 of the second CN 130 may be coupled to the access node 104 of the first CN 110.

Table 1, shown below, is a non-limiting illustrative example of a table that may be compiled by the access node 104 of the first RAN 106 to cross-reference each logical instance of each device 102, 103 to a dedicated MME. The VESM tags represented in table 1 are for illustration only. The VESM tag may be, for example, a concatenation of a logical instance identifier and an address identifier assigned to the physical device. For example, the VESM tag VESM_ID1 could be LLC-RNTI1 or L1.GUTI1. Either would uniquely associate the first logical instance, L1, of device A 102 with MME A 112 in first CN 110. Each VESM tag may identify a unique NAS context between the device and a given MME.

TABLE 1

| | | | | VESM Tag | |
|---|---|---|---|---|---|
| | Logical | | | (Context- | |
| | Instance | Physical | Physical | Unique | Dedicated |
| Device | Identifier | Address | Address | Identifier) | MME |
| A | L1 | C-RNTI1 | GUTI1 | VESM_ID1 | MME A |
| (102) | | | | | (112) |
| A | L2 | C-RNTI1 | GUTI2 | VESM_ID2 | MME B |
| (102) | | | | | (114) |
| A | L3 | C-RNTI1 | GUTI3 | VESM_ID3 | MME C |
| (102) | | | | | (116) |
| B | L1 | C-RNTI2 | GUTI4 | VESM_ID4 | MME B |
| (103) | | | | | (114) |
| B | L2 | C-RNTI2 | GUTI5 | VESM_ID5 | MME C |
| (103) | | | | | (116) |
| B | L3 | C-RNTI2 | GUTI6 | VESM_ID6 | MME D |
| (103) | | | | | (134) |
| B | L4 | C-RNTI2 | GUTI7 | VESM_ID7 | MME A |
| (103) | | | | | (112) |

### Multiple NAS Contexts

Aspects provided herein allow for a device to be split into multiple logical instances, and for each logical instance to be represented by a unique NAS context. Each NAS context may be associated with one of a plurality of MMEs, where each of the plurality of MMEs is dedicated to one or more services. The radio link between the device and an access node is thereby shared by a plurality of NAS contexts.

There is presently a tight connection (e.g., a one-to-one relationship) between the use of a radio link (e.g., for user plane and RRC signaling connections in case of LTE) and the NAS context established for the client device. A NAS context, as a whole, may be defined with reference to two parts, namely an evolved mobility management context (EMM context) and an evolved session management context (ESM context). In the case of LTE, when a client device forms a connection with a network, the EMM context part and the ESM context part are created in a mobility management entity (MME); both parts of the NAS context are associated with the radio link. There is a one-to-one association between the NAS context (via its EMM and ESM context parts) and the radio link. The aspects presented herein, however, provide for a many-to-one relationship between NAS contexts and the radio link.

At present, the standard setting body known as the Third Generation Partnership Project (3GPP) is considering a model where for a set of a given type of device (e.g., machine-to-machine (M2M) type devices such as refrigerators, washing machines, scales, alarm systems), dedicated mobility management entities (MMEs) will be provisioned in the network. MME selection performed in an access node (e.g., eNB) will consider the type of device in selecting an MME. In other words, if certain MMEs are dedicated for M2M data, then each access node will have pre-existing instructions to connect an M2M type device to the specific MME in the network that is dedicated to M2M data. However, devices typically encompass more than one type of functionality. Accordingly, aspects described herein may support multiple concurrent NAS contexts between one physical client device and multiple dedicated MMEs on a single radio link.

Multiple concurrent NAS contexts may be beneficial, for example, because specific services (e.g., an M2M service, a World Wide Web search service, a video streaming service) may be delivered and controlled by specific and dedicated MMEs (i.e., delivered and controlled by specific and dedicated functionality in a core network). With multiple concurrent NAS contexts, each NAS context may be represented by its own subscription/credential, which would be convenient for service access policy enforcement and charging, for example.

By implementing multiple NAS contexts, aspects described herein may make it possible to enable both an ability to provide multiple dedicated network functionality (e.g., multiple dedicated MMEs) for the provisioning of multiple services to a single device using a single subscriber credential, and also to support additional distinct subscriber credentials for each context (e.g., a first credential for business related applications, a second credential for a first set of personal applications, and a third credential for a second set of personal (or business) applications).

### Multiple Credentials Within One Device

The explanation that follows makes reference to subscriber identity module (SIM) cards for illustrative purposes only. The aspects described herein are not limited to client devices that use SIM cards, or to any type of device or system implementing standards that make use of credentials stored on SIM cards. Moreover, although the aspects described herein may make reference to certain terms that are typically associated with the 3GPP standard referred to as long term evolution (LTE), nothing herein is intended to limit the aspects described herein to such a standard.

A subscriber identity module (SIM) card stores a unique set of credentials. A SIM card stores an international mobile subscriber identity (IMSI) number and a related key. The IMSI and related key may be used to identify and authenticate a subscriber using a client device (e.g., user equipment, mobile phones, and mobile devices). One or more subscriptions may be associated with a subscriber. Therefore, one or more subscriptions may be associated with the unique set of credentials, such as those found on a given SIM card.

A user's employer may provide the user with a first SIM card for subscriptions to business related services. For example, the services may include a suite of office services (e.g., word processing, spreadsheet, etc.), a geographic mapping service, and an on-line audio-visual meeting service. The user may have a second SIM card for subscriptions to personal (non-business) services. For example, the services may include a suite of photography-based services (e.g., photograph storage, enhancement, and printing), a social media service, and a video streaming service. Although not represented in the preceding exemplary lists, one service may be separately subscribed to by the employer and the user (i.e., two subscriptions to the same service).

The user may want a client device to use both SIM cards at the same time. Indeed, in some markets, there are mobile devices that simultaneously hold two SIM cards. However, even in these markets, only those services associated with one credential can be used on one radio link at one time. As used herein, a radio link is defined by a radio resource control (RRC) connection. Accordingly, the user cannot today simultaneously use one service associated with a first credential while using a second service associated with a second credential on the same radio link (i.e., over the same RRC connection). As a consequence, today's client devices are limited to support operation of only one RRC connection associated with one credential on the client device at a given time. As used herein, an RRC connection may be thought of as a client device context established between the client device and an access node (e.g., eNodeB).

The concept of one RRC connection associated with one credential on one client device at a given time can be visualized when a first credential is associated with a first SIM card and a second credential is associated with a second SIM card. However, the same concept is applicable in devices with one SIM card or in devices with no SIM card. In these devices, it may also be possible to establish multiple credentials to associate with multiple subscriptions and/or services.

As described above, specific services may be delivered and controlled by dedicated functionality in a core network (CN) (e.g., dedicated serving nodes, dedicated MMEs). For ease of reference, the devices implementing the dedicated functionality will be referred to as dedicated MMEs. Each CN may have a plurality of dedicated MMEs. Each dedicated MME may be reserved to provide its functionality to at least one service, where the service attended to by a first MME would be different from the service attended to by a second MME.

A single client device may have several subscriptions and/or services associated with it. For example, a client device (e.g., a wearable multi-function cellular communication device) may offer functionality that includes an ability to measure and record pulse rate as a function of time. It may also offer functionality associated with voice calling and streaming video. A user may obtain a subscription to a pulse measuring service that periodically uploads data from the client device. Such a service may have a relatively low priority (similar to the priority of a M2M type service). The user may also obtain a second subscription to a voice service and a third subscription to a streaming video service, each having relatively high priorities.

Today, there are not dedicated MMEs for each of the three subscriptions/services. When dedicated MMEs are implemented, a problem may occur. Today, one RRC connection corresponds to only one NAS context between the access node and an MME. In general, the NAS context defines the parameters established for signaling data exchange between the client device and the MME. Today, only one MME is presently associated with a client device at any given time. Aspects described herein provide a way to establish multiple NAS contexts between a client device and multiple MMEs based on one RRC connection over a shared radio link. Each NAS context may corresponds to a separate subscription and/or service.

A client device may be split into distinct logical instances of itself. Within the client device, distinct subscriptions and/or services might each be associated with a corresponding distinct logical instance of the client device. Each logical instance (sometimes referred to herein as a logical context) of the device nay have its own unique credential.

Each logical instance of the device may be associated with a separate NAS context (i.e., EMM/ESM context) associated with one MME. In accordance with this aspect, a single physical client device may be served by multiple MMEs. Each MME serving at least one of the logical instances of the device via a specific NAS context.

Virtual ESM with Existing Security Model

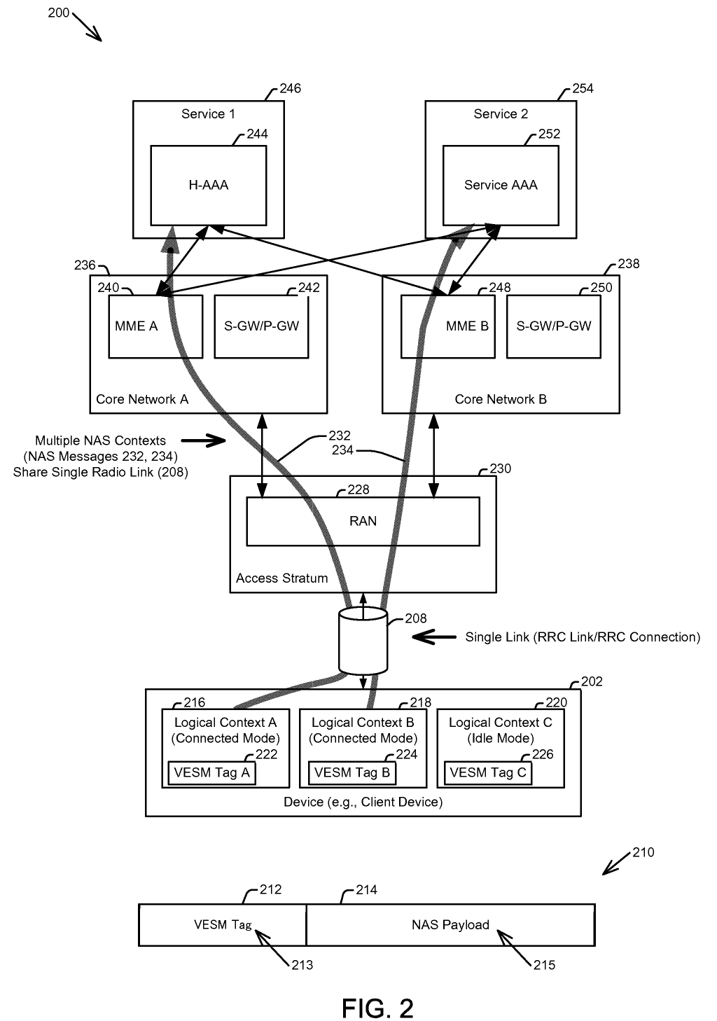

FIG. 2 is a block level diagram 200 illustrating concurrent connectivity of two logical instances of a client device 202 with two distinct MMEs, MME A 204 and MME B 206, via one radio resource control (RRC) connection 208. FIG. 2 also depicts a generalized packet 210 having a header portion 212 and a payload portion 214. The header portion 212 may include a VESM tag 213. The payload portion 214 may include an NAS payload 215. FIG. 2 further depicts the client device 202 as being split into three logical instances, Logical Context A 216, Logical Context B 218, and Logical Context C 220. Each logical context is depicted as being associated with a distinct VESM tag, VESM Tag A 222, VESM Tag B 224, and VESM Tag C 226, respectively.

A radio access network (RAN) 228 is depicted as existing within an access stratum 230. The access stratum 230 provides services to the non-access stratum (NAS). Among the services provided by the access stratum 230 is the transport of NAS messages between NAS entities. NAS protocols apply between a client device, such as client device 202, and a core network, such as core network A 236 and/or core network B 238. The access stratum 230 transports NAS signaling. NAS signaling is not terminated at the access stratum 230.

The one RRC connection 208 is depicted as existing between the client device 202 and the RAN 228. The one RRC connection 208 between the client device 202 and the RAN 228 is split logically into multiple NAS contexts, NAS Context A 232 and NAS Context B 234. NAS Context A 232 is established in association with Logical Context A 216 of the client device 202. Logical Context A 216 is depicted as being in a connected mode. NAS Context B 234 is established in association with Logical Context B 218 of the client device 202. Logical Context B 218 is depicted as being in a connected mode. No NAS context is illustrated in association with Logical Context C 220, as Logical Context C 220 is depicted as being in an idle mode. Any one or more of the logical contexts of the client device 202 may be in an idle mode or a connected mode at any given time.

Core Network A 236 and core network B 238 are each coupled to RAN 228. CN A 236 includes a first MME, MME A 240. CN A 236 additionally includes a serving gateway (S-GW) and a packet data network gateway (P-GW) 242. A first AAA server 244 is coupled to MME A 240. The first AAA server 244 is associated with a first service, Service A 246. Core network B 238 includes a second MME, MME B 248. Core network B 238 additionally includes a serving gateway (S-GW) and a packet data network gateway (P-GW) 250. A second AAA server 252 is coupled to MME B 248. The second AAA server 252 is associated with a second service, Service B 254. In addition, MME A 240 may be coupled to second AAA server 252 and MME B 248 may be coupled to first AAA server 244.

In one aspect, NAS messages for each logical instance of the client device 202 may be multiplexed over the one RRC connection 208 (e.g., the one RRC signaling link layer of a communication protocol stack). For example, NAS context A 232 of Logical Context A 216 and NAS Context B 234 of Logical Context B 218 of the client device 202 may be multiplexed over the one RRC connection 208.

In the aspects described herein, an NAS context (e.g., NAS context A 232) between a first logical instance (e.g., Logical Context A 216) of a client device (e.g., client device 202) and a first MME (e.g., MME A 240) may be independent of another NAS context (e.g., NAS Context B 234) between a second logical instance (e.g., Logical Context B 218) of the client device (e.g., client device 202) and a second MME (e.g., MME B 248). That is, they share no relationship despite being transported on a single radio link (one RRC connection 208) within a communication protocol stack. Accordingly, the first NAS Context A 232 between Logical Context A 216 of client device 202 and MME A 240 may be independent of NAS Context B 234 between Logical Context B 218 of the client device 202 and MME B 248.

According to the aspects described herein, many NAS contexts may be multiplexed onto one RRC connection. That is, according to the aspects described herein, there may be a many-to-one mapping of many NAS contexts to one RRC connection (e.g., one RRC connection 208).

When the client device 202 establishes connectivity for one of the NAS contexts (e.g., NAS Context A 232, NAS Context B 234), for example if the client device 202 performs an attach procedure in connection with Logical Context A 216, the client device 202 may derive a VESM tag, such as VESM Tag A 222 to associate with the first NAS context (e.g., NAS Context A 232). The VESM tag may be a client device derived identifier or the VESM tag may be an RAN (or eNodeB) derived identifier. Any suitable name to refer to such an identifier, such as “VESM tag” or “context-unique identifier” is acceptable.

In one aspect, the VESM tag A 222 may be allocated by the client device 202 and is unique within the client device 202. In another aspect, when the client device 202 establishes connectivity for one of the logical contexts, for example if the client device 202 performs an attach procedure for Logical Context A 216, the RAN 228 may generate the VESM tag (e.g., VESM Tag A 222) for the Logical Context A 216 and return it to the client device 202 upon successful establishment of NAS Context A 232.

In one aspect the VESM tag may not be required to be unique with respect to other client devices. In such an aspect, the RAN 228 handling the NAS contexts may use the VESM tag in connection with, for example, the physical address or identity of the client device 202 that transmitted the NAS context, and/or in connection with temporary identifiers that the RAN 228 may have assigned to the client device 202 (e.g. c-RNTI in case of LTE). Accordingly, in such an aspect, there may be no need to have VESM tags unique with respect to other client devices. Even if two client devices are using the same VESM tag, there should be no overlap because the physical addresses of the client devices, or their identities, are different.

In another aspect, the RAN 228 may allocate a VESM tag that may be unique within an access node (e.g., eNB) within the RAN 228. In an additional aspect, the RAN 228 may allocate a VESM tag that may be unique to a set of access nodes, and that may contain an identifier of a given access node (e.g. cell identity, eNB identity, etc.)

Once the VESM Tag A 222 has been allocated to Logical Context A 216, the client device 202 may start packaging the signaling from Logical Context A 216 with VESM Tag A 222. An access node (e.g., eNB) within the RAN 228 receiving an NAS payload 215 from the client device 202 may have stored a cross reference between VESM Tag A 222, the client device 202 physical address, NAS context A 232, and Logical Context A 216. (see, for example, Table 1, above). The access node will accordingly be able to associate NAS payload 215, associated with VESM Tag A 222, with NAS Context A 232.

According to one aspect, when the client device 202 performs the next attach procedure with, for example, Logical Context B 218, a second VESM tag (e.g., VESM Tag B 224) may be derived and allocated to Logical Context B 218. The client device 202 may package the signaling associated with Logical Context B 218 with the second VESM tag (e.g., VESM Tag B 224). The derivation, allocating, and packaging of VESM tags for signaling may occur each time the client device 202 performs a new attach procedure for a new logical instance.

Accordingly, when an access node within the RAN 228 receives a communication from a client device 202, the access node may be able to determine how to forward the communication based at least on the VESM tag 213 packaged with the NAS payload 215 and the physical address of the client device 202 or the identity of the client device 202. In this way, an access node within the RAN 228 may be able to direct the NAS payload to a first MME (e.g., MME A 240) associated with a first core network 236, or a second MME (e.g., MME B 248) associated with the second core network, core network B 238. The use of VESM tags may permit the signal bearers and data bearers of one logical context to be distinguished from the signal bearers and data bearers of other logical contexts. The use of two core networks and two MMEs is for illustrative purposes only. There is no limit on the number of logical contexts, core networks, or MMEs within a core network.

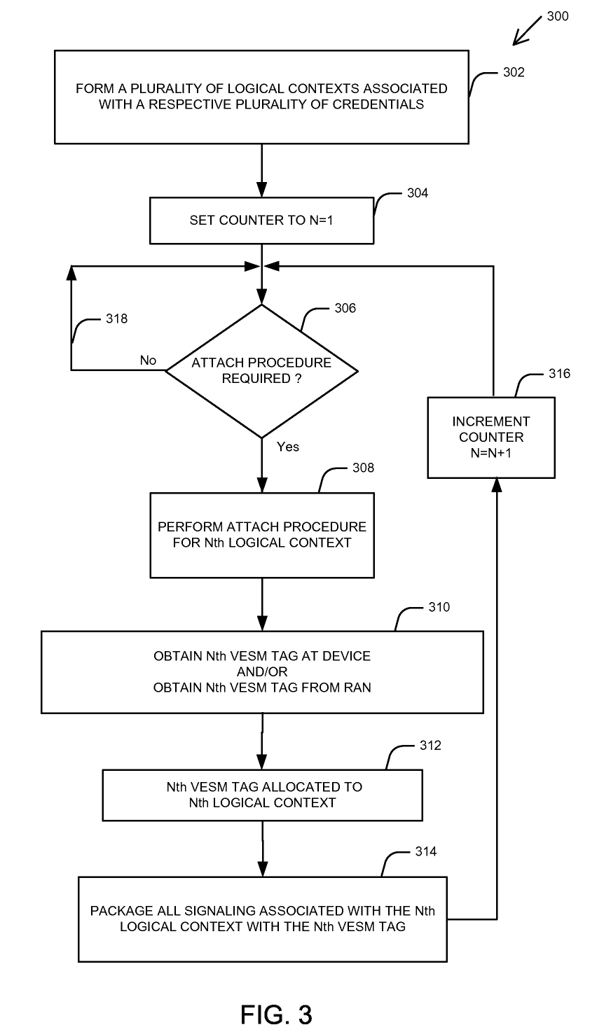

FIG. 3 is a flow diagram of a method 300 in accordance with an aspect described herein. A processor of a client device may form 302 a plurality of logical contexts associated with a respective plurality of credentials stored in a memory device. A counter may be set 304 to a value of N=1. The client device may determine 306 that it needs to perform an attach procedure for one of the plurality of logical contexts. If the client device determines that it does need to perform an attach procedure for one of the plurality of contexts, the client device may perform 308 the attach procedure for a first logical context in the plurality of logical contexts. In exemplary additive or alternate aspects, upon connection (e.g., successful context establishment), the client device may derive an Nth identifier (e.g., VESM tag, context-unique identifier) for the first logical context and/or the client may request or otherwise obtain 310 the Nth identifier from a radio access network (RAN) (e.g., access node or eNB). The Nth identifier (e.g., VESM tag, context-unique identifier) may be allocated 312 to the first logical context by the client device in one exemplary aspect or by the RAN in an alternate exemplary aspect. The client device may package 314 signaling associated with the first logical context with the Nth identifier (e.g., VESM tag, context-unique identifier). The counter may be incremented 316 to N+1. The method may return to the step where client device may again determine 106 whether it needs to perform an attach procedure for one of the plurality of contexts. If the client device determines that it does not need to perform an attach procedure for one of the plurality of contexts the method may return 318 to a step of determining if the client device needs to perform an attach procedure for one of the plurality of contexts.

In summary, according to aspects described herein, a client device may allocate a VESM tag to identify separate logical contexts. The client device may mark corresponding NAS data with the same VESM tag. The term VESM tag is not intended to be limiting. A client device may identify each logical client device instance using any form of identification so that each logical instance may be distinguished from another.

In one aspect, an access node (e.g., eNodeB, eNB) may store the VESM tags corresponding to the client device for each logical context for each active instance. In this way the access node may discriminate between data from multiple logical contexts from the same client device. The access node may use a new or stored VESM tag for NAS routing to carry NAS signaling to the correct MME. VESM tags may be used to make multiple active logical instances of a client device appear to the core network as separate logical connections.

When an access node needs to trigger a handover, it may need to notify MMEs to which the physical client device is attached, and therefore it may need to have knowledge of the identities of MMEs having sessions with logical contexts of the physical client device. According to one aspect, the storage of the VESM tags corresponding to the active instances of logical contexts of the client device may be useful in handover.

### Exemplary Architectural Model

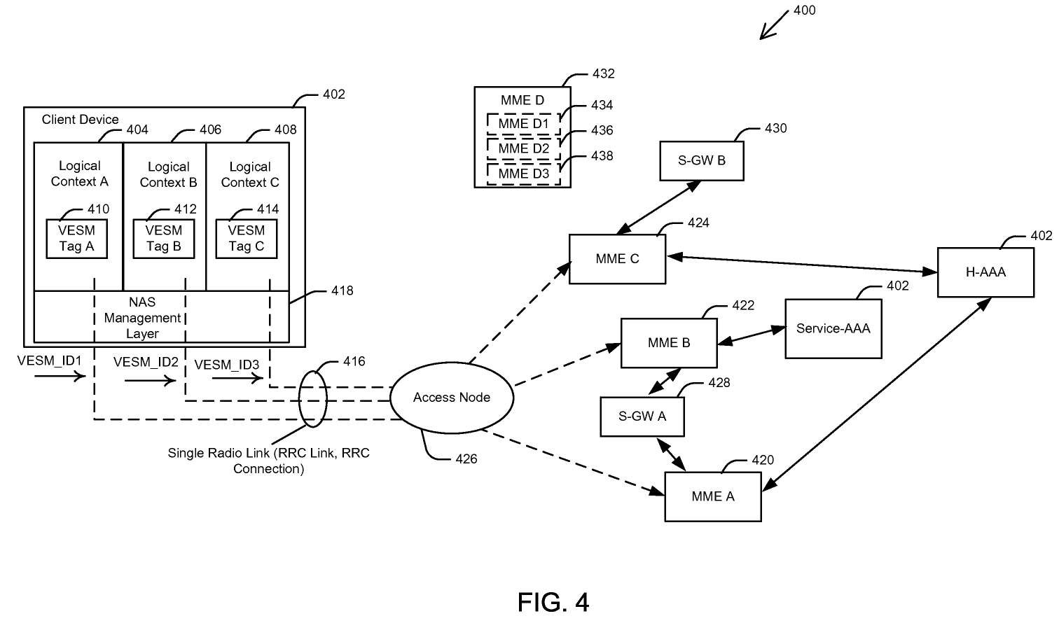

FIG. 4 is an exemplary architectural model of a system 400 making use of VESM tags to distinguish between NAS contexts flowing over a single RRC connection to a plurality of MMEs. FIG. 4 depicts a single physical client device 402 having three logical contexts, Logical Context A 404, Logical Context B 406, and Logical Context C 408. The number of logical contexts is not intended to be limiting. Each of the three logical contexts represents a different subscription and/or credential used to establish the context. The three logical contexts have each been allocated with unique VESM tags (VESM Tag A 410, VESM Tag B 412, VESM Tag C 414). The signaling for the three logical contexts may be provided over the RRC connection 416 (e.g., single radio link). All of the illustrated signaling flows through an NAS Management Layer 418. The signaling may be discriminated using the derived VESM tags and physical address of the client device 402.

In the illustration of FIG. 4, the three logical contexts are serviced by three physical MMEs (e.g., serving nodes), MME A 420, MME B 422, MME C 424. In one aspect any physical MME can be split into multiple logical instances of itself. For example, MME D 432 is logically split into MME D1 434, MME D2 436, and MME D3 438. There is no limit on the number of logical instances of an MME. Any logical context (e.g., Logical Context A 404, Logical Context B 406, and Logical Context C 408) could be serviced by a logical instance of a physical MME. Accordingly, in such an aspect it may be possible to have a one-to-one mapping of each logical context (Logical Context A 404, Logical Context B 406, and Logical Context C 408) to a corresponding logical instance of an MME. A plurality of MMEs (e.g., serving nodes) may therefore be comprised of a plurality of logical instances of one or more physical MMEs (e.g., serving nodes). Accordingly, there may be one MME (e.g., serving node) that has a plurality of logical instances, such that the one MME (e.g., serving node) can support a plurality of contexts associated with one device. Context is associated with a plurality of subscriptions.

According to one aspect of operation, the NAS Management Layer 418 of client device 402 may generate unique VESM tags (e.g. VESM Tag A 410, VESM Tag B 412, VESM Tag C 414) for each of the three logical contexts (Logical Context A 404, Logical Context B 406, and Logical Context C 408). The NAS Management Layer 418 of client device 402 may maintain a mapping of the client device logical context (e.g., Logical Context A 404, Logical Context B 406, and Logical Context C 408) to VESM tags (e.g. VESM Tag A 410, VESM Tag B 412, VESM Tag C 414). The NAS Management Layer 418 of client device 402 may maintain a mapping of application/services to logical context (e.g., Logical Context A 404, Logical Context B 406, and Logical Context C 408). The mapping may be set by a user or may be set without user interaction by the logical context itself. The NAS Management Layer 418 of client device 402 may additionally maintain a mapping of data bearers to VESM tags.

The security context of the NAS Management Layer 418 may be the same as that of the access node 426. The access node 426 may select a security context based on the client device 402 identifier (e.g., GUTI) and the VESM tag associated with a given logical context.

According to one aspect, an access node 426 may make an MME selection when no routing to an MME can be determined from the information provided by the client device.

An access node may also be utilized for “bridging” or coordination of multiple ESM contexts in that it may store information related to the multiple contexts for purposes, for example, of mapping and supporting S-GWs.

For example, mapping of C-RNTI to VESM tags, VESM tags to MMEs identities, VESM tags to security contexts, and VESM tags to serving gateway used for the client device may be facilitated by the information related to the multiple contexts that may be stored by an access node (e.g. eNB).

An access node may also be enhanced to detect a request for a VESM tag in messages from the client device for context establishment, or to detect the absence of a VESM tag (e.g. when the client device provides a null VESM tag). Upon detection of a request for a VESM tag or an absence of a VESM tag, the access node may derive and allocate a VESM tag to the logical context of the client device.

According to another example related to S-GWs, an access node may be configured with a list of “preferred” S-GWs and, upon new client device context establishment in the access node, the access node may provide an MME with one or more suggestions as to which S-GW to use. This may be introduced because the MME may be deployed by an entity different from the entity deploying the RAN and the S-GWs, and may not know the network topology may thus not be capable of selecting the appropriate S-GW to serve the client device.

According to another example related to S-GWs, an access node may store information about selected S-GWs and the identities of MMEs that selected the S-GWs.

In the case of a single S-GW model, an access node may store an indication of whether S-GW relocation for non-mobility events is acceptable. For example, an MME may request no relocation; the access node may decide, for example, based on policies, the operator may only allow an operator-owned MME to relocate the S-GW for non-mobility events. In such an event, the access node may store an identity of a “deciding MME” for S-GW relocation at mobility.

The access node may further be used to provide a selected S-GW to a new MME (upon an additional ESM context establishment).

The access node may further be configured to authorize an MME request to relocate to an S-GW. For example, based on policies, the operator may only allow an operator-owned MME to relocate the S-GW for non-mobility events.

In accordance with one aspect, if an access node authorizes an S-GW relocation by an MME, then the access node may communicate to other MMEs the need to relocate the S-GW.

According to one aspect of operation, the access node 420 may maintain a mapping of Cell Radio Network Temporary Identifier (C-RNTI) to VESM tags to know the active logical contexts of the client device 402. Each C-RNTI is unique for each client device 402. For each VESM tag, the access node 420 may maintain a mapping that associates each logical context of the client device to a serving MME. It may also maintain a mapping that associates each VESM tag to a GUTI allocated by the serving MME.

With regard to the security context of the access node 420, for each VESM tag, the access node 420 may securely store the security context (keys) derived/obtained from the corresponding MME. In case of single signal radio bearer (SRB), the access node may use the last security context created to protect all NAS messages independently of the NAS context being transmitted. In case of multiple SRBs, the access node may apply the security context based on the VESM tag that is associated with the NAS message being transmitted. The access node 420 may select a security context based on the GUTI and MME ID (e.g., MME ID used to derive the VESM tag).

In connection with each serving gateway (S-GW), in accordance with the aspects of Virtual ESM, there may be two models. For the first model, there may be a single S-GW for all logical instances of the client device. For the second model, there may be separate S-GWs, one for each client device-MME instance.

An access node (e.g., eNB) may maintain mapping between logical contexts of the client device and a corresponding S-GW based on VESM tags.

The access node 420 may map the VESM tag to the S-GW corresponding to that context (if more than one S-GW is in use). The access node 420 may also map data bearers to VESM tags and data radio bearer (DRB) identities.

The access node 420 may perform initial S-GW selection from a set of default S-GWs. If the S-GW is (re)selected by an MME, the access node 420 may maintain a mapping of the selected S-GW, which MME selected it, and whether another MME can override the selection.

The access node 420 may perform paging. If on a shared link, the access node may forward a paging notification for a first logical context (e.g., Logical Context A 404) over a second logical context (e.g., Logical Context B 406) and may mark the paging notification with the VESM tag (e.g., VESM Tag A 410) and Gun of the first logical context (e.g., Logical Context A 404). If not on a shared link, the access node may send a paging notification, in which it adds the VESM tag of the logical context being paged, on a paging channel.

According to one aspect of operation, an S-GW (e.g., S-GW A 428, S-GW B 430) may maintain a mapping of logical contexts to serving MMEs and access nodes. Optionally, the S-GW may map multiple logical contexts of a physical client device based on information received from MMEs and access nodes (where the access nodes may provide an indication of which tunnels of different client devices relate to the same physical client device at tunnel setup between access node and S-GW). The S-GW may also perform intelligent paging if the S-GW knows one of the other logical instances of the client device is active (i.e., the S-GW may provide the MME with the address of the serving access node).

According to aspects described herein, MME functionality may extend to NAS signaling, NAS signaling security, inter-CN node signaling for mobility between 3GPP access networks, UE Reachability in ECM-IDLE state (including control, execution of paging retransmission and optionally Paging Policy Differentiation), Tracking Area (TA) list management, P-GW selection, and. S-GW selection.

In connection with S-GW selection, an MME may receive an indication of an existing S-GW (for other VESM contexts) and, based on service specific information, decide a different S-GW may be needed.

In a single S-GW model, an MME may receive an indication of an existing S-GW (for other VESM contexts) and, based on service specific information, decide a different S-GW may be needed. The MME may request an access node to relocate the S-GW and provide an indication of override with respect to other MMEs. If the access node authorizes the relocation of the S-GW, according to one aspect, the MME may select the chosen S-GW, otherwise it may use the existing one.

In addition to the previously mentioned MME functionalities, the MME may also be responsible for MME selection for handovers with an MME change, SGSN selection for handovers to 2G or 3G 3GPP access networks, bearer management functions including dedicated bearer establishment, and for client device reachability (e.g., UE Reachability) procedures.

According to one aspect of operation, the MME may maintain EMM and ESM contexts as in regular NAS. It may optionally maintain the VESM tag associated with the context.

According to one aspect of operation, the MME may perform S-GW reselection if the current S-GW provided by access node is not suitable.

According to one aspect of operation, the MME may perform paging of the client device as normal or, if it receives the identity of the access node from the S-GW, the MME may send the paging request only to current access node.

### Virtual ESM Tagging for Connectivity

According to one aspect, a client device may be split into logical instances of itself. A link between the client device and a network may be split logically in multiple virtual links. Each virtual link may correspond to a logical instance of the client device.

A VESM tag may be derived by the client device or by the RAN (or by an access node of the RAN) and assigned to each logical instance of the client device. Signaling data (e.g. control plane signaling, NAS messages) may be associated with an assigned VESM tag. The association may be, for example, for identification. Association may be made by marking, inserting, appending to, or otherwise including the VESM tag with the signaling data. Thus, the client device may associate the VESM tag with each NAS message it sends to an MME (e.g., the client device may insert the VESM tag in a NAS container sent to an MME) to identify the context associated with the message. The VESM tag may be comprised of a part that is unique at least within a client device and a part that identifies the client device. In this way, the VESM tag as a whole may uniquely distinguish one context in a plurality of contexts of a device from another context in a plurality of devices. A VESM tag may be thus be used as an identifier in a plurality of devices and may be more efficient than a globally unique temporary client device identity (GUTI). A VESM tag may be used to identify context (e.g., NAS context) locally within a radio access network (RAN). A single RRC connection may handle signaling data associated with one or more VESM tags.

An access node (e.g., eNB) may store the VESM tag together with an identity of the client device (e.g., GUTI and/or radio network temporary identifier (RNTI) when allocated) thus allowing the access node to uniquely identify the context of the device (from among a plurality of contexts of the device) to which the signaling belongs.

The access node may also store the mapping between the VESM tag and the MME associated to the client device context corresponding to the VESM tag. Upon context establishment (e.g., attach/authentication) or handover, the access node may store the mapping between the VESM tag and the MME identity.

Upon receiving an RRC message from the client device with a NAS container marked with a VESM tag, the access node may check the VESM tag. If the access node determines an association between the VESM tag and a given client device (e.g., by lookup table or other method known to those of skill in the art), the access node may forward the signaling (i.e., message) to a corresponding MME. If a new VESM tag is detected, the access node may perform MME selection according to current mechanisms and the information the client device provides in the request, even if there is already a RAN context for this client device (e.g., there is already a cell C-RNTI associated with this client device). If a request for a VESM tag is detected, or the absence of a VESM tag is detected, the access node may derive and provide a VESM tag and perform MME selection according to current mechanisms and the information the client device provides in the request, even if there is already a RAN context for this client device (e.g., there is already a cell-radio network temporary identifier (C-RNTI) associated with this client device).

The access node may also store the VESM tags corresponding to the client device in a single context for the active instances. This may be necessary at handover, so that the access node is aware of which MMEs are serving the client device to trigger appropriate handover preparation signaling (i.e., towards the MMEs serving the active contexts of the logical client device instances in the physical client device).

According to one aspect, use of Virtual ESM may not require any change to a client device state model. That is, the client device state model for devices/systems implementing Virtual ESM may, in some aspects, be the same model as that found, for example, in 4G.

According to the aspects discussed herein, the modes of each client device logical context may be independent. As used herein, the term “mode” may be used to describe a status of an RRC connection (e.g., connected, idle, and in some aspects, standby). For example, in one scenario, a first context may be in connected mode while a second context may be in idle mode. In this scenario, the client device may have to listen to idle mode pages for the second context. Additionally, a client device may have different tracking areas for different logical contexts. According to one aspect, the client device may be in connected mode for one context and in idle mode for the other contexts.

According to aspects described herein, mobility may be handled separately. For example, when an access node triggers a handover, it may only do so for the connected NAS contexts. This may mean, for example, that a first instance may be handed over to a new access node, whereas a second instance may remain idle. In some aspects, handover of one instance may trigger the other instance(s) to perform a tracking area update (TAU) procedure, because, for example, the client device may now camp on a second access node with a second instance context.

### Two Models for Use of an RRC Connection

In use, there may be two models of RRC connections. Namely, a first model in which there is a single RRC connection and a second model in which there are multiple RRC connections.

In order to use the model in which there is a single RRC connection for multiple NAS contexts (e.g., multiplexed RRC), an access node may be enabled to route more than one NAS message in the same RRC message to the appropriate MMEs. The client device may send NAS messages for different contexts in the same RRC message or in different messages. The RRC message used to carry NAS signaling may have an inner container (which may be in or outside a packet data convergence protocol service data unit (PDCP SDU)) having, for example, the format:

RRC_MSG (<UEID1, NAS_MSG>; <UEID2, NAS_MSG>; . . . )

where the UEID can be an SAE-Temporary Mobile Subscriber identity (S-TMSI) (where SAE stands for System Architecture Evolution and S-TMSI=MME Code (MMEC)+MME Mobile Subscriber Identity (M-TMSI)) or MME identifier (MMEI)+M-TMSI assigned by the MME serving the specific contexts, or a different label.

If the RRC message contains a NAS message for contexts unknown to the access node (e.g., the access node does not recognize the context-unique identifier), the access node may perform MME selection for that NAS message based on the information in the NAS message and possibly from RRC information.

In order to use the model in which there are multiple RRC connections for the separate multiple NAS contexts, the client device may have completely separate RRC connections for each of the NAS contexts. When the physical client device needs to send multiple NAS messages corresponding to different logical client device instances, the client device may generate multiple separate RRC procedures (e.g., establish multiple separate RRC connections) even if a single radio link is used.

The access node may provide an indication to the client device of the model to be used e.g. multiplexed RRC (single RRC connection) or multiple RRC connections.

### Signal Radio Bearer (SRB) Model (Multiple SRBs)

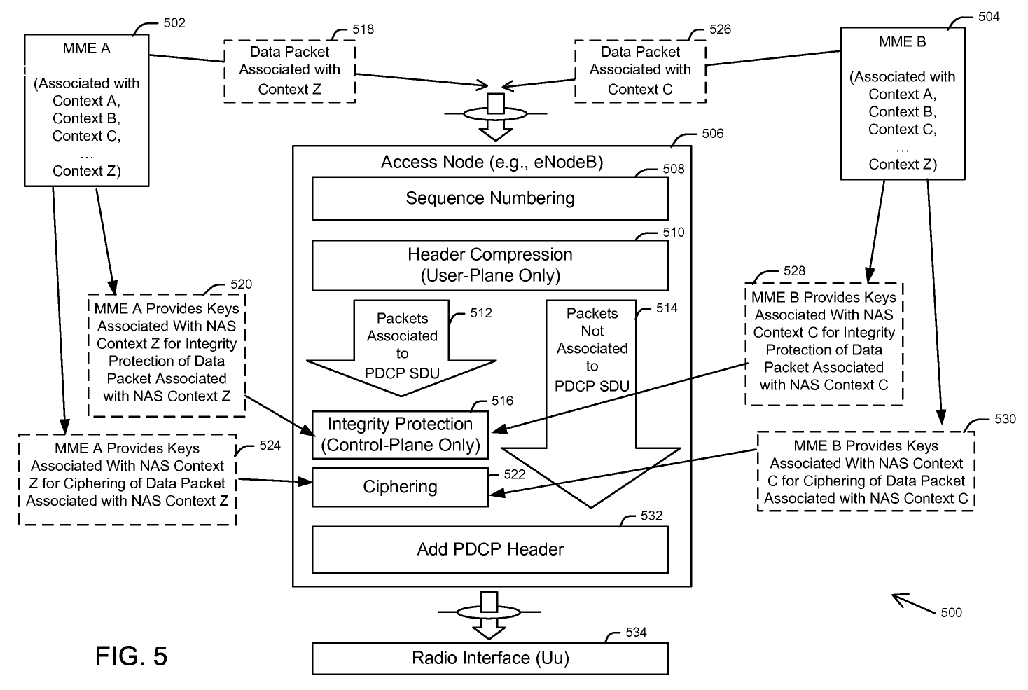

FIG. 5 is an exemplary block diagram of a signal radio hearer (SRB) and data radio bearer (DRB) security model 500 for use with multiple SRBs, including a new layer of protection for NAS. FIG. 5 depicts two MMEs, MME A 502 and MME B 504. Each MME may be associated with a plurality of contexts (e.g., NAS contexts). Each MME may maintain multiple security contexts associated with the plurality of contexts of a single physical device (e.g., client device). In other words, each MME may maintain a security context for each logical context of a given physical device.

A packet entering an access node 506 is subject to sequence numbering 508. If the packet is associated with user-plane data, the packet is subject to header compression 510. Header compression 510 is pertinent only to packets in the user-plane. Packets next follow two separate routes. A first route 512 is for packets associated with a packet data convergence protocol service data unit (PDCP SDU), while a second route 514 is for packets that are not associated with a PDCP SDU. For packets associated with a PDCP SDU, if the packet is a control-plane packet, the packet is subject to integrity protection 516. Integrity protection 516 is pertinent only to packets in the control-plane. The data (e.g., c-plane signaling data) subject to integrity protection 516 is associated with a given NAS context. The given NAS context is one of a plurality of NAS contexts associated with the MME that provided the data. The given NAS context is associated with a security context. The security context may specify a key that should be used to protect the data associated with the given NAS context. The MME that provided the data to the access node 506 may provide the key to the access node 506, where the key will be used in connection with integrity protection of the data associated with the given NAS context.

In the exemplary illustration of FIG. 5, MME A 502 sends 518 a data packet associated with context Z to the access node 506. MME A 502 provides 520 keys associated with NAS context Z for integrity protection of the data packet associated with NAS context Z.

The packet may then be subject to ciphering 522. MME A 502 provides 524 keys associated with NAS context Z for ciphering 522 of the data packet associated with NAS context Z.

Similarly, in the exemplary illustration of FIG. 5, MME B 504 sends 526 a data packet associated with context C to the access node 506. MME B 504 provides 528 keys associated with NAS context C for integrity protection of the data packet associated with NAS context C.

The packet may then be subject to ciphering 522. MME B 504 provides 530 keys associated with NAS context C for ciphering 522 of the data packet associated with NAS context C.

The packets may then receive PDCP headers 532 before being sent via the over the air-interface (Uu) 534 to a client device.

According to a first aspect, a first option for use of RRC and security context considers multiple SRBs. According to such an aspect, every PDCP packet may be marked with a VESM tag. For identification purposes, a common C-RNTI may be used for multiple logical client devices. According to the first aspect, multiple NAS messages may not be sent in the same RRC packet. Each RRC packet may be protected with the corresponding security context. According to the first aspect, the security context may be based on a VESM tag. Accordingly, the client device would know to use the security context of the corresponding VESM tag on each RRC packet. According to the first aspect, an access node will have multiple security contexts, for example, as many as the number of NAS contexts and VESM tags. To accommodate multiple SRBs according, for example, to the first aspect, may requires changes to the RRC message sequence to support multiple NAS sessions.

### Signal Radio Bearer (SRB) Model (Single SRBs)

According to a second aspect, a second option for use of RRC and security context considers single SRBs. According to such an aspect, do to multiplexing, multiple NAS messages for different contexts can be carried over one RRC message. According to such an aspect, the RRC protection algorithm may be chosen by the access node. The client device may send the same capabilities (from a security point of view) to various MMEs independently of the specific credentials. Therefore, independently of which context is used to protect the RRC, the strength of protection may be the same. In one aspect, the security context used to protect the RRC message may be last security context chosen.

### Flow Diagrams

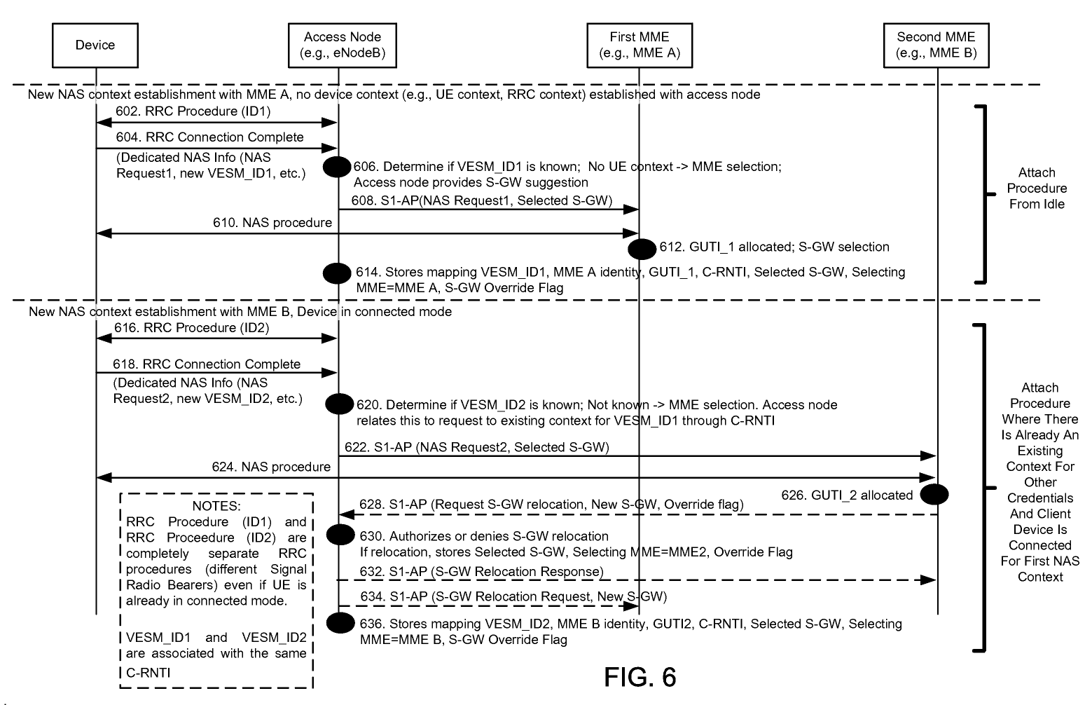

FIG. 6 is an exemplary flow diagram illustrating a first initial NAS context establishment with a first MME and a subsequent second initial NAS context establishment with a second MME. In the non-limiting exemplary illustration of FIG. 6, the two NAS contexts are established sequentially. Such sequential NAS context establishment may be referred to herein as serial NAS context signaling. According to the aspects of FIG. 6, a first RRC procedure is executed followed by establishment of a first NAS context between the device (e.g., chip component, client device) and a first MME (e.g., MME A). A second RRC procedure is executed followed by establishment of a second NAS context between the device and a second MME (e.g., MME B). Accordingly, at the conclusion of the serial NAS context signaling, two NAS contexts are concurrently established between one device and two MMEs.

In the scenario presented by FIG. 6, a device context (e.g., UE context, RRC context) with an access node is not established prior to the events depicted in FIG. 6. The scenario presented by FIG. 6 is for illustrative and non-limiting purposes.

The device performs 602 the steps of an RRC procedure with an access node using a first identifier. In some aspects, the device derives the first identifier (e.g., ID1). The first identifier may correspond to one logical instance of the device; it may correspond to an identity of a first NAS context being established. In some aspects, some combination of the first identifier (i.e., an identifier of one logical context in a plurality of logical contexts of the device) and an identity of the device itself may be used to derive a VESM tag. In the example of FIG. 6, a VESM tag corresponding to ID1 and the device may be referred to as VESM_ID1. The device sends 604 an RRC Connection Complete message to the access node at the conclusion of the RRC procedure.

With the Connection Complete message, the device sends dedicated NAS information. The dedicated NAS information may include a NAS message (e.g., NAS Request1) and a new VESM tag (e.g., VESM_ID1), among other things.

The access node may determine 606 if there is an existing NAS context corresponding to the device and the VESM tag VESM_ID1. The determination may be made, for example, by evaluating data stored in a table in the access node. The table may cross-reference known VESM tags to devices and MMEs. If the table, or other cross-referencing mechanism, identifies an existing NAS context corresponding to the device and VESM_ID1, the access node can use the information in the table to map the NAS message to the appropriate MME. If no NAS context corresponding to the device and VESM_ID1 is identified by the access node, the access node may perform MME selection and provides a suggestion for which S-GW to select. In the scenario of FIG. 6 (for exemplary purposes), there is no NAS context corresponding to the device and VESM_ID1; the access node selects, for illustrative purposes, MME A. Consequently, the access node performs 608 an S1 attach procedure (S1-AP) with the selected MME (e.g., MME A) and sends the NAS message (e.g., NAS Request1) and the selected S-GW to the selected MME (e.g., MME A).

At MME A, the MME may perform 610 a NAS procedure in accordance with the information in the NAS message (e.g., NAS Request1). In some aspects, the NAS procedure may include device authentication based on the information included in the dedicated NAS information (see step 604). MME A may allocate 612 a global UE temporary identifier (GUTI) to the device and may perform S-GW selection if the S-GW suggested by the access node is not preferred. In the example of FIG. 6, the GUTI allocated to the logical instance of the device (i.e., the logical instance of the device corresponding to the just-established NAS context) by MME A is referred to as GUTI_1.

If the MME performs S-GW reselection, it provides the new S-GW to the access node and indicates to the access node whether another MME can reselect the S-GW by setting the S-GW override flag.

Upon success of the NAS procedure, MME A forwards the security context associated with the NAS context, and forwards the selected S-GW, to the access node (not shown).

The access node may perform mapping of device identifiers to context identifiers, mapping of context identifiers to MME identifiers, mapping of context identifiers to security contexts, mapping of context identifiers to serving gateways, and may store 614 mapping results in a memory device at the access node. In other words, the access node may store 614 a mapping of a device identifier to an identifier of a logical context of the device (e.g., VESM_ID1), a mapping of a logical context of the device to an identity of an MME (e.g., MME A), a mapping of a logical context of the device to a security context associated with the logical context of the device, a mapping of a logical context of the device to a serving gateway, and may store 614 mapping results in a memory device at the access node. The access node may additionally store the selected S-GW, the selecting MME=MME A, and the value of the S-GW override flag (e.g., flag is set, or not set).

In the example of FIG. 6, a second RRC connection to the same access node is established for a second NAS context. If the device went into idle mode, the device performs 616 the steps of a new RRC procedure with the access node using a second identifier. In some aspects, the device derives the second identifier (e.g., ID2). The second identifier may correspond to a second logical instance of the device; it may correspond to an identity of a second NAS context being established. In some aspects, some combination of the second identifier (i.e., an identifier of the second logical context in a plurality of logical contexts of the device) and an identity of the device itself may be used to derive a VESM tag. In the example of FIG. 6, a VESM tag corresponding to ID2 and the device may be referred to as VESM_ID2. The device sends 618 an RRC Connection Complete message to the access node at the conclusion of the second RRC procedure.

With the Connection Complete message, the device sends dedicated NAS information. The dedicated NAS information may include a NAS message (e.g., NAS Request2) and a new VESM tag (e.g., VESM_ID2), among other things.

The access node may determine 620 if there is an existing NAS context corresponding to the device and the VESM tag VESM_ID2. Because the same C-RNTI is used by the access node for every logical instance of the device, in one aspect, the access node may relate the request for the second NAS context to the existing NAS context associated with the device and VESM_ID1. If the access node determines that there is an existing context corresponding to the device and VESM_ID2, then the access node may forward the NAS message to the MME associated with that existing context. If the access node determines that there is not an existing NAS context corresponding to the device and VESM_ID2, the access node may perform MME selection and provides a suggestion for which S-GW to select. In the scenario of FIG. 6 (for exemplary purposes), there is no NAS context corresponding to the device and VESM_ID2; the access node selects, for illustrative purposes, MME B. Consequently, the access node performs 622 an S1 attach procedure (S1-AP) with the selected MME (e.g., MME B) and sends the NAS message (e.g., NAS Request2) and the selected S-GW to the selected MME (e.g., MME B).

At MME B, the MME may perform 624 a NAS procedure in accordance with the information in the NAS message (e.g., NAS Request2). In some aspects, the NAS procedure may include device authentication based on the information included in the dedicated NAS information (see step 618). The MME B may also allocate 626 a GUTI to the NAS context associated with VESM_ID2. The MME and may perform S-GW selection if the S-GW suggested by the access node is not preferred. In the example of FIG. 6, the GUTI allocated to the logical instance of the device (i.e., the logical instance of the device corresponding to the just-established NAS context associated with VESM_ID2) by MME B is referred to as GUTI_2.

If the MME performs S-GW reselection, it provides the new S-GW to the access node and indicates to the access node whether another MME can reselect the S-GW by setting the S-GW override flag.

Optionally, if MME B decides that the S-GW suggested by the access node is not acceptable, and the S-GW override flag enables S-GW relocation, MME B may initiate 628 an S1-AP with a request for S-GW relocation to the access node. MME B may provide the new S-GW address to the access node. MME B may also indicate to the access node whether another MME can reselect the S-GW by setting the S-GW override flag.

The access node authorizes or denies S-GW relocation 630 based, for example, on local configuration and policies. If relocation is enabled, the access node may store the selected S-GW as the S-GW selected by MME B (e.g., Selecting MME=MME B), and store the value of the override flag as set by MME B. The access node sends 632 an S1-AP (S-GW Relocation Response) to the MME B.

Then the access node informs 634 other MMEs (in the example of FIG. 6, the access node informs MME A) of the S-GW relocation made by MME B by sending an S1-AP (S-GW Relocation Request, New S-GW) message to the other MMEs.

Upon success of the NAS procedure, MME B forwards the security context associated with the NAS context, and forwards the selected S-GW, to the access node (not shown).

The access node may perform mapping of device identifiers to context identifiers, mapping of context identifiers to MME identifiers, mapping of context identifiers to security contexts, mapping of context identifiers to serving gateways, and may store 614 mapping results in a memory device at the access node. In other words, the access node may store 614 a mapping of a device identifier to an identifier of a logical context of the device (e.g., VESM_ID1), a mapping of a logical context of the device to an identity of an MME (e.g., MME A), a mapping of a logical context of the device to a security context associated with the logical context of the device, a mapping of a logical context of the device to a serving gateway, and may store 614 mapping results in a memory device at the access node. The access node may additionally store the selected S-GW, the selecting MME=MME B, and the value of the S-GW override flag (e.g., flag is set, or not set).

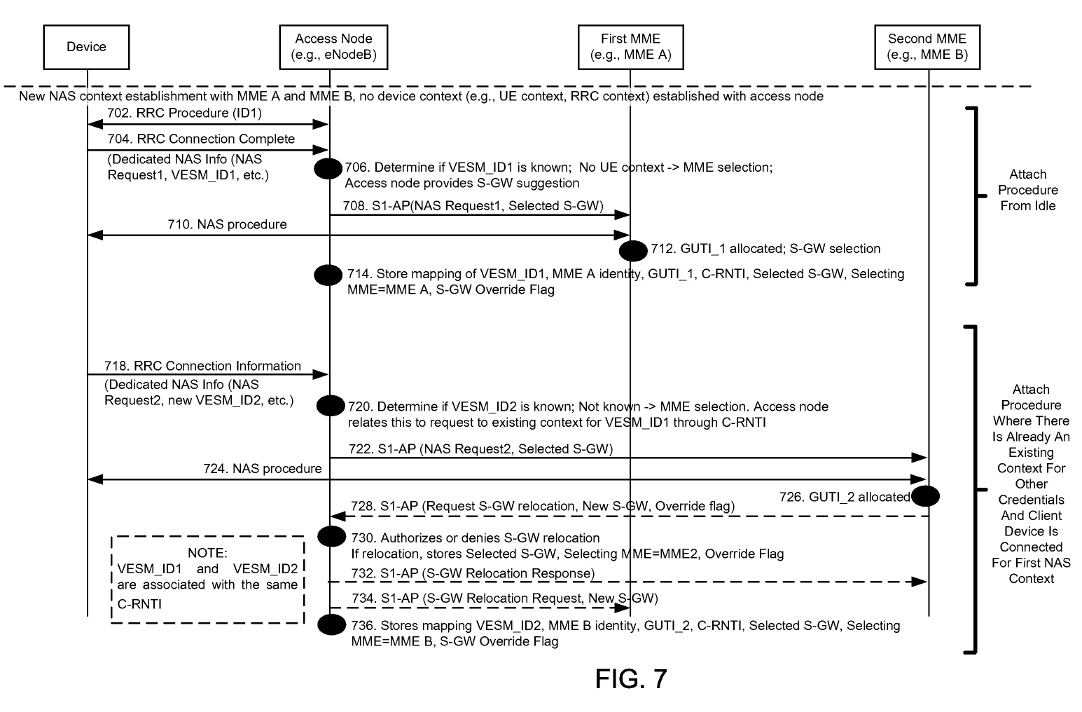

FIG. 7 is an exemplary flow diagram illustrating initial NAS context establishment between a device (e.g., chip component, client device) and both a first MME and a second. MME. In the non-limiting exemplary illustration of FIG. 7, the two NAS contexts may be established concurrently. Such concurrent NAS context establishment may be referred to herein as simultaneous NAS context signaling. According to the aspects of FIG. 7, a first RRC procedure is executed followed by establishment of a first NAS context between the device (e.g., chip component, client device) and a first MME (e.g., MME A). In contrast to the scenario presented by FIG. 6, a second. RRC procedure is not executed. Instead, the device (which remains in a connected mode) sends a new type of RRC message. The new type of RRC message may be identified herein as “RRC Connection information” message. The RRC Connection Information message may include the same content as an RRC Connection Complete message. The RRC Connection information message is followed by establishment of a second NAS context between the device (e.g., chip component, client device) and a second MME (e.g., MME B). Accordingly, at the conclusion of the simultaneous NAS context signaling, two NAS contexts are concurrently established between one device and two MMEs.

In the scenario presented by FIG. 7, a device context (e.g., UE context, RRC context) with an access node is not established prior to the events depicted in FIG. 7. The scenario presented by FIG. 7 is for illustrative and non-limiting purposes,

The device performs 702 the steps of an RRC procedure with an access node using a first identifier (e.g., ID1). In some aspects, the device derives the first identifier. The first identifier may correspond to one logical instance of the device; it may correspond to an identity of a first NAS context being established. In some aspects, some combination of the first identifier (i.e., an identifier of one logical context in a plurality of logical contexts of the device) and an identity of the device itself may be used to derive a VESM tag. In the example of FIG. 7, a VESM tag corresponding to ID1 and the device may be referred to as VESM_ID1. The device sends 704 an RRC Connection Complete message to the access node at the conclusion of the RRC procedure.

With the Connection Complete message, the device sends dedicated NAS information. The dedicated NAS information may include a NAS message (e.g., NAS Request1) and a new VESM tag (e.g., VESM_ID1), among other things.

The access node may determine 706 if there is an existing NAS context corresponding to the device and the VESM tag VESM_ID1. The determination may be made, for example, by evaluating data stored in a table at the access node. The table may cross-reference known VESM tags to devices and MMEs. If the table, or other cross-referencing mechanism, identifies an existing NAS context corresponding to the device and VESM_ID1, the access node can use the information in the table to map the NAS message to the appropriate MME. If no NAS context corresponding to the device and VESM_ID1 is identified by the access node, the access node may perform MME selection and provide a suggestion for which S-GW to select. In the scenario of FIG. 7 (for exemplary purposes), there is no NAS context corresponding to the device and VESM_ID1; the access node selects, for illustrative purposes, MME A. Consequently, the access node performs 708 an S1 attach procedure (S1-AP) with the selected MME (e.g., MME A) and sends the NAS message (e.g., NAS Request1) and the selected S-GW to the selected MME (e.g., MME A).

At MME A, the MME may perform 710 a NAS procedure in accordance with the information in the NAS message (e.g., NAS Request1). In some aspects, the NAS procedure may include device authentication based on the information included in the dedicated NAS information (see step 704). MME A may allocate 712 a global UE temporary identifier (GUTI) to the device and may perform S-GW selection if the S-GW suggested by the access node is not preferred. In the example of FIG. 7, the GUTI allocated to the logical instance of the device (i.e., the logical instance of the device corresponding to the just-established NAS context) by MME A is referred to as GUTI_1.

If the MME performs S-GW reselection, it provides the new S-GW to the access node and indicates to the access node whether another MME can reselect the S-GW by setting the S-GW override flag.

Upon success of the NAS procedure, MME A forwards the security context associated with the NAS context, and forwards the selected S-GW, to the access node (not shown).

The access node may perform mapping of device identifiers to context identifiers, mapping of context identifiers to MME identifiers, mapping of context identifiers to security contexts, mapping of context identifiers to serving gateways, and may store 714 mapping results in a memory device at the access node. In other words, the access node may store 614 a mapping of a device identifier to an identifier of a logical context of the device (e.g., VESM_ID1), a mapping of a logical context of the device to an identity of an MME (e.g., MME A), a mapping of a logical context of the device to a security context associated with the logical context of the device, a mapping of a logical context of the device to a serving gateway, and may store 614 mapping results in a memory device at the access node. The access node may additionally store the value of the S-GW override flag (e.g., flag is set, or not set).

In the example of FIG. 7, a second RRC connection to the same access node is established for a second NAS context. In some aspects, the device derives a second identifier (e.g., ID2). The second identifier may correspond to a second logical instance of the device; it may correspond to an identity of a second NAS context being established. In some aspects, some combination of the second identifier (i.e., an identifier of the second logical context in a plurality of logical contexts of the device) and an identity of the device itself may be used to derive a VESM tag. In the example of FIG. 7, a VESM tag corresponding to ID2 and the device may be referred to as VESM_ID2.

In the scenario of FIG. 7, the first RRC connection remains in the connected mode (i.e., an active mode), there is no need to begin a new RRC procedure. Instead, the device may send a new type of RRC message to the access node. The new type of RRC message may be referred to herein as an “RRC Connection Information” message. The RRC Connection Information message may include the same content as an RRC Connection Complete message.

The device may send 718 the RRC Connection Information message, which may include dedicated NAS information. The dedicated NAS information may include a NAS message (e.g., NAS Request2) and a new VESM tag (e.g., VESM_ID2), among other things.

The access node may determine 720 if there is an existing NAS context corresponding to the device and the VESM tag VESM_ID2. Because the same C-RNTI is used by the access node for every logical instance of the device, in one aspect, the access node may relate the request for the second NAS context to the existing NAS context associated with the device and VESM_ID1. If the access node determines that there is an existing context corresponding to the device and VESM_ID2, then the access node may forward the NAS message to the MME associated with that existing context. If the access node determines that there is not an existing NAS context corresponding to the device and VESM_D2, the access node may perform MME selection and provide a suggestion for which S-GW to select. In the scenario of FIG. 7 (for exemplary purposes), there is no NAS context corresponding to the device and VESM_ID2; the access node selects, for illustrative purposes, MME B. Consequently, the access node performs 722 an S1 attach procedure (S1-AP) with the selected MME (e.g., MME B) and sends the NAS message (e.g., NAS Request2) and the selected S-GW to the selected MME (e.g., MME B).

At MME B, the MME may perform 724 a NAS procedure in accordance with the information in the NAS message (e.g., NAS Request2). In some aspects, the NAS procedure may include device authentication based on the information included in the dedicated NAS information (see step 718). MME B may also allocate 726 a GUTI to the NAS context associated with VESM_ID2. The MME and may perform S-GW selection if the S-GW suggested by the access node is not preferred. In the example of FIG. 7, the GUTI allocated to the logical instance of the device (i.e., the logical instance of the device corresponding to the just-established NAS context associated with VESM_ID2) by MME B is referred to as GUTI_2.

If the MME performs S-GW reselection, it provides the new S-GW to the access node and indicates to the access node whether another MME can reselect the S-GW by setting the S-GW override flag.

Optionally, if MME B decides that the S-GW suggested by the access node is not acceptable, and the S-GW override flag enables S-GW relocation, MME B may initiate 728 an S1-AP with a request for S-GW relocation to the access node. MME B may provide the new S-GW address to the access node. MME B may also indicate to the access node whether another MME can reselect the S-GW by setting the S-GW override flag.

The access node authorizes or denies S-GW relocation 730 based, for example, on local configuration and policies. If relocation is enabled, the access node may store the selected S-GW as the S-GW selected by MME B (e.g., Selecting MME=MME B), and store the value of the override flag as set by MME B. The access node sends 732 an S1-AP (S-GW Relocation Response) to MME B.

Then the access node informs 734 other MMEs (in the example of FIG. 7, the access node informs MME A) of the S-GW relocation made by MME B by sending an S1-AP (S-GW Relocation Request, New S-GW) message to the other MMEs.

Upon success of the NAS procedure, MME B forwards the security context associated with the NAS context, and forwards the selected S-GW, to the access node (not shown).

The access node may perform mapping of device identifiers to context identifiers, mapping of context identifiers to MME identifiers, mapping of context identifiers to security contexts, mapping of context identifiers to serving gateways, and may store 736 mapping results in a memory device at the access node. In other words, the access node may store 736 a mapping of a device identifier to an identifier of a logical context of the device (e.g., VESM_ID2), a mapping of a logical context of the device to an identity of an MME (e.g., MME B), a mapping of a logical context of the device to a security context associated with the logical context of the device, a mapping of a logical context of the device to a serving gateway, and may store 736 mapping results in a memory device at the access node. The access node may additionally store the selected S-GW, the selecting MME=MME B, and the value of the S-GW override flag (e.g., flag is set, or not set).

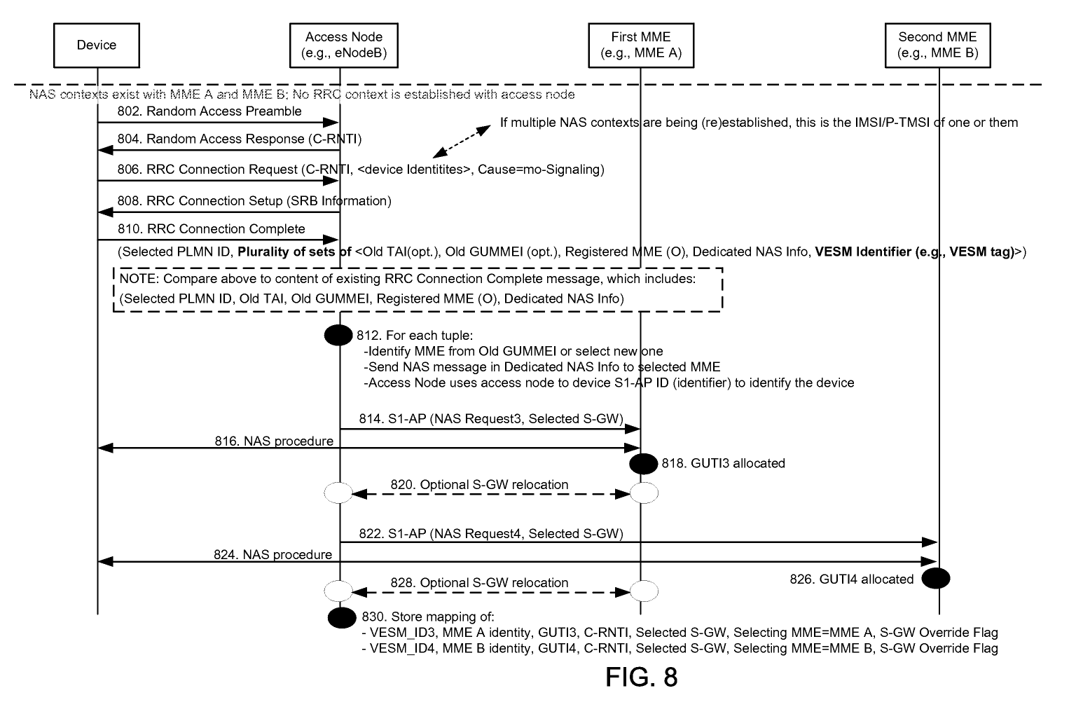

FIG. 8 is an exemplary flow diagram illustrating initial NAS context establishment in a scenario of simultaneous NAS signaling. In the aspect of FIG. 8, NAS contexts may exist with MME A and MME B; however, no RRC context exists between the device and the access node. In the example of FIG. 8, one or more new NAS context(s) may be established or re-established.

The device may perform the initial steps of the RRC connection setup including sending 802 of a Random Access Preamble. A Random Access Response may be received 804; the Random Access Response includes a C-RNTI, which is allocated to the device from the access node.

The device sends 806 an RRC Connection Request to the access node. The RRC Connection Request may include the C-RNTI. The RRC Connection Request may also include “<device identities>”, where if multiple NAS contexts are being (re)established, the <device identities> may be the international mobile subscriber identity (IMSI) and/or the packet domain temporary mobile subscriber identity (P-TMSI) of one of them. In the nomenclature of LTE, this element may be referred to as <UE-Identity>, which is included to facilitate contention resolution by lower layers.

The RRC Connection Request may also include an establishment cause, which in the aspect described herein may be the “mo-Signaling” establishment cause. The mo-signaling establishment cause may correspond to the NAS procedures of attach, detach, and tracking area update (TAU).

The access node may send 808 an RRC Connection Setup message that nay include signal radio bearer (SRB) information.

The device may next send 810 an RRC Connection Complete message to the access node. However, in a present RRC Connection Complete message there is only information related to one NAS context. That is, the present message format for an RRC Connection Complete message may include a Selected Public Land Mobile Network Identifier (PLMN ID), the old tracking area information (TAI), the old globally unique mobility management entity identifier (GUMMEI), the Registered MME (O), and the Dedicated NAS Info for the single NAS context between the access node and the selected MME. The GUMMEI, as used presently, includes a PLMN ID, a Mobility Management Entity (MME) group identity, and an MME code. The MME code may be used in the access node by an NAS selection function to select an MME.

In contrast, according to aspects described herein, there may be a new format, where a new RRC Connection Complete message may include RRC Connection Complete, a Selected PLMN ID, and a set of information related to each of the NAS contexts. For example, the set of information related to each of the NAS contexts may be expresses as a tuple, where the tuple may include an Old GUMMEI (opt.), an Old TAI (opt.), a Registered MME (O), Dedicated NAS Info, and a VESM Tag ID.

In other words, in connection with an RRC Connection Complete message, the device may provide the tuple <Old GUMMEI (opt.), Old. TAI (opt.), Registered MME (O), Dedicated NAS Info, VESM tag> to the access node.

For each tuple, the access node may identify 812 an associated MME from the old GUMMEI or may select a new MME. In one aspect, the access node determines if there is an existing NAS context corresponding to the <device identities> and the VESM tag. On one hand, if there is an existing NAS context corresponding to the <device identities> and the VESM tag, then the access node forwards the NAS message to the MME associated with that context. An access node may use an access node to device S1-AP ID (S1 attach procedure ID) to identify the device.

In the exemplary illustration of FIG. 8, two MMEs (MME A, MME B) are shown. With respect to the first MME, MME A, the access node may execute 814 an S1-AP procedure with MME A. The S1-AP may include a NAS Request (e.g., NAS Request3), the content of the Dedicated NAS Info, the Selected S-GW, and the S-GW Override Flag. The NAS context may be associated with a particular VESM tag (e.g., VESM_ID3). MME A and the device may perform 816 the NAS procedure. This NAS procedure may include device authentication based on the information in the Dedicated NAS Info. The MME may allocate 818 GUTI_3 to the device. The MME A and access node may optionally perform 820 S-GW relocation if the S-GW suggested by the access node is not preferred.

Because the RRC Connection Complete message includes a plurality of sets (tuples) of information elements related to a plurality of VESM tags, additionally NAS context establishments may take place. For example, with respect to the second MME, MME B the access node may execute 822 an S1-AP procedure with MME B. The S1-AP may include a NAS Request (e.g., NAS Request4), the content of the Dedicated NAS Info, the Selected S-GW, and the S-GW Override Flag. The NAS context may be associated with a particular VESM tag (e.g., VESM_ID4). The MME A and the device may perform 824 the NAS procedure. This NAS procedure may include device authentication based on the information in the Dedicated NAS Info. The MME may allocate 826 GUTI_4 to the device. The MME A and access node may optionally perform 830 S-GW relocation if the S-GW suggested by the access node is not preferred.

The access node may store 830 mappings of the parameters of each of the sets (tuples) of information relating to each of the NAS contexts in a memory device. For example, for the third NAS context established, the access node may store a cross-reference between the VESM identifier (e.g., VESM_ID3) and GUTI_3, C-RNTI, the selected S-GW, Selecting MME (=MME A), and the S-GW override flag value. For the fourth NAS context established, the access node may store a cross-reference between the VESM identifier (e.g., VESM_ID4) and GUTI_4, C-RNTI, the selected S-GW, Selecting MME (=MME B), and the S-GW override flag value.

VESM_ID3 and VESM_ID4 are associated to the same C-RNTI, which in the example of FIG. 8 is identified as C-RNTI.

Note, steps 814-820 and steps 822-828 may occur in parallel.

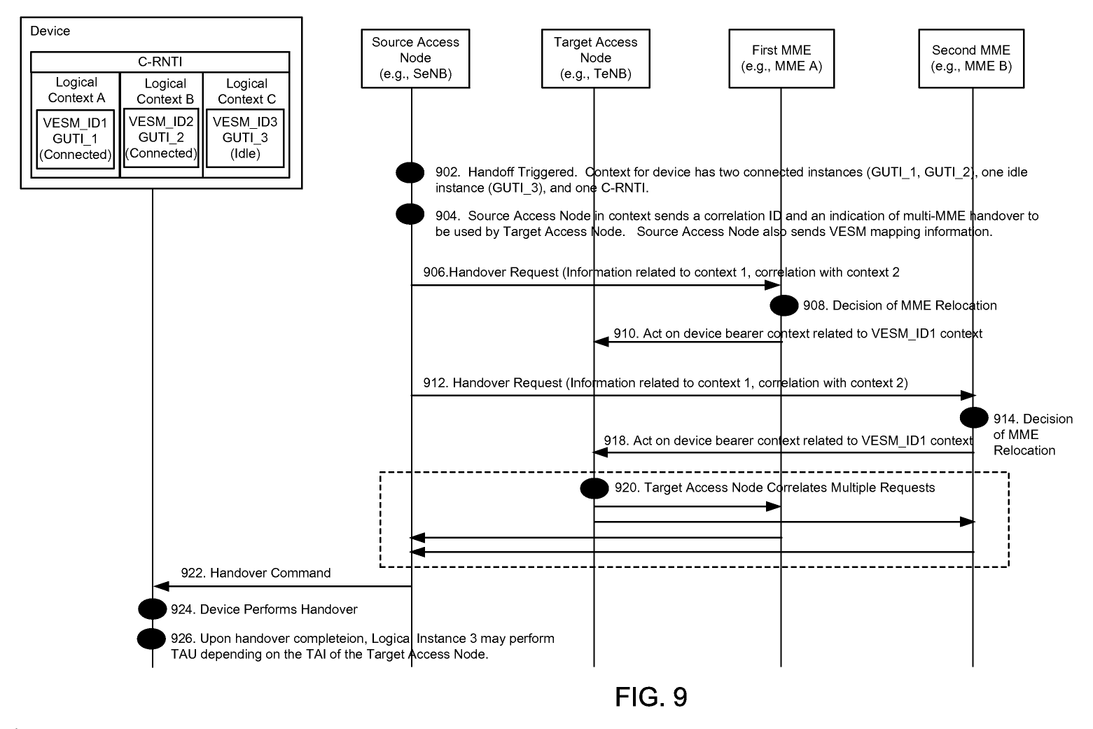

FIG. 9 is an exemplary flow diagram illustrating a basic case of a handover in which two logical instances (Logical Context A and Logical Context B) of a device are in an active (e.g., connected) mode while a third logical instance (Logical Context C) of the device is in an inactive (e.g., idle) mode.

A source access node (e.g., source eNB or SeNB) may trigger 902 a handover (HO). The RRC context for the device has two active instances (Logical Context A and Logical Context B) and one inactive instance (Logical Context C). The first instance (Logical Context A) may be associated with a first NAS context and a first GUTI (GUTI_1). The first GUTI may be provided by a first MME (MME A) in association with the first NAS context between the device and the first MME. In the figure, VESM_ID1 is a VESM tag associated with the first context. The second instance (Logical Context B) may be associated with a second NAS context and a second GUTI (GUTI_2). The second GUTI may be provided by a second MME (MME B) in association with the second NAS context between the device and the second MME. In the figure, VESM_ID2 is a VESM tag associated with the second context. The third instance (Logical Context C) may be associated with a third NAS context and a third GUTI (GUTI_3). The third GUTI may be have been provided by a third MME (not shown) in association with the third NAS context between the device and the third MME. In the figure, VESM_ID3 is a VESM tag associated with the third context).

Only one C-RNTI is involved in the handover. The C-RNTI is provided to the device as a whole by the access node.

The source access node (e.g., SeNB) sends 904 a correlation ID and an indication of multi-MME handover to be used by the target access node (e.g., target eNB or TeNB). The source access node may also send VESM mapping information (e.g., VESM tag to GUTI identifier, MME identifier, etc.) to the target access node.

The source access node may then send 906 a first handover request to MME A. The first handover request may include information related to logical context A of the device (i.e., the context associated with VESM_ID1). The first handover request may additionally include an indication of the correlation between the information related to logical context A and logical context B (i.e., the context associated with VESM_ID2). MME A may make 908 an MME relocation decision on the handover. MME A may then act 910 on device bearer context(s) related to the VESM_ID1 context by sending a message to the target access node.

The source access node may then send 912 a second handover request to MME B. The second handover request may include information related to logical context B of the device (i.e., the context associated with VESM_ID2), and an indication of a correlation between that information and logical context A of the device (i.e., the context associated with VESM_ID1). MME B may make 914 MME relocation decision on the handover. MME B may then act 916 on device bearer context(s) related to the VESM_ID2 context by sending a message to the target access node.

In some aspects, the relocation decisions made by the individual MMEs are independent decisions related to bearer context.

The target access node may correlate 920 the multiple handover requests. The target access node may send a first message to MME A and may send a second message to MME B. MME A may send a third message to the source access node. MME B may send a fourth message to the source access node. The source access node may then send 922 a handover (HO) command to the device. The device may then perform 930 handover. Upon handover completion, Logical Context C of the device, which was in idle mode during the handover operation, may perform 926 tracking area update (TAU) depending on the tracking area information (TAI) of the target access node.

### Exemplary Device

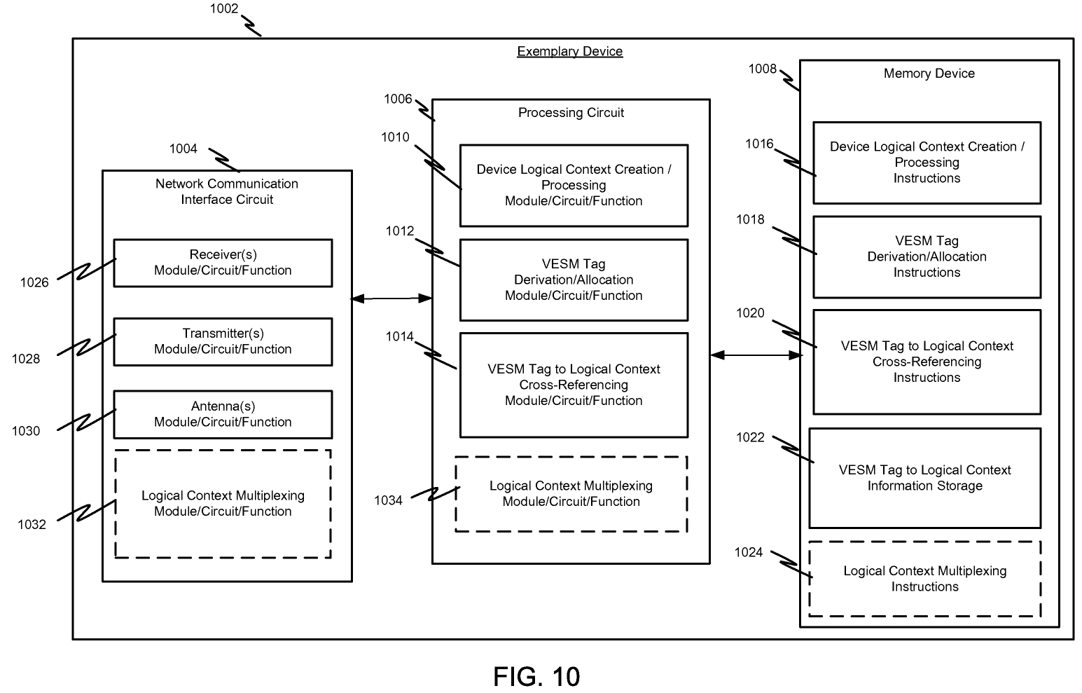

FIG. 10 illustrates an exemplary device 1002 (e.g., chip component, client device) configured to support multiple connections and credential sets and support concurrent operation of multiple NAS con texts with multiple MMEs.

The device 1002 of FIG. 10 may include a network communication interface circuit 1004 configured to communicate over a wireless network, a processing circuit 1006, and a memory device 1008 that may be operationally coupled to one another.

The network communication interface circuit 1004, may serve to couple the device 1002 to one or more networks via one or more radio access networks using one or more wireless access technologies that facilitate establishing a wireless link to other devices/networks/services. Accordingly, the network communication interface circuit 1004 may be configured to facilitate wireless communications of the device 1002. The network communication interface circuit 1004 may include one or more receiver module/circuit/functions 1026, one or more transmitter module/circuit/functions 1028, and/or one or more antenna module/circuit/functions 1030. The receiver(s) 1026, transmitter(s) 1028, and antenna(s) 1030 may be operationally coupled to one another. The antenna(s) 1030 may facilitate wireless communication with the one or more client devices, networks, and/or services. Additionally, a module/circuit/function to implement logical context multiplexing 1032 for data on a Layer 2 radio link of a communication protocol stack or on an RRC layer of the protocol stack may be optionally included in whole or in part in the network communication interface circuit 1004.

The processing circuit 1006 may be operationally coupled to the network communication interface circuit 1004. The processing circuit 1006 may include a device logical context creation/processing module/circuit/function 1010, a VESM tag derivation/allocation module/circuit/function 1012, and/or a VESM tag to logical context cross-referencing module/circuit/function 1014. Additionally, a module/circuit/function to implement logical context multiplexing 1034 for data on a Layer 2 radio link of a communication protocol stack or on an RRC layer of the protocol stack may be optionally included in whole or in part in the processing circuit 1006.

The processing circuit 1006 may be arranged to obtain, process, format, and/or send data, control data access and storage, issue commands, and control other desired operations. The processing circuit 1006 may include circuitry adapted to implement desired programming provided by appropriate non-transient media in at least one example. For example, the processing circuit 1006 may be implemented as one or more processors, one or more controllers, and/or other structure configured to execute executable programming. Examples of the processing circuit 1006 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 1006 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 1006 are for illustration and other suitable configurations are within the scope of the present disclosure are also contemplated.

The processing circuit 1006 may be adapted for processing, including the execution of programming, which may be stored on the memory device 1008. As used herein, the term “programming” may be construed broadly to include without limitation instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The memory device 1008 may be operationally coupled to the processing circuit 1006 and may also may be operationally coupled to the network communication interface circuit 1004. The memory device 1008 may include device logical context instructions 1016, VESM tag generation/allocation instructions 1018, VESM tag to logical context cross-referencing instructions 1020, VESM tag to logical context information storage 1022, and/or logical context multiplexing instructions 1024.

The memory device 1008 may include one or more non-transient computer-readable, machine-readable, and/or processor-readable devices for storing programming, such as processor executable code or instructions (e.g., software, firmware), electronic data, databases, or other digital information. The memory device 1008 may also be used for storing data that may be manipulated by the processing circuit 1006 when executing programming. The memory device 1008 may be any available non-transient media that can be accessed by a general purpose or special purpose processor, including portable or fixed storage devices, optical storage devices, and various other non-transient media adapted to store, contain, and/or carry programming. By way of example and not limitation, the memory device 1008 may include a non-transient computer-readable, machine-readable, and/or processor-readable storage medium such as a magnetic storage device (e.g., hard disk, floppy disk, magnetic strip), an optical storage device (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and/or other media for non-transient storage of programming, as well as any combination thereof.

The memory device 1008 may be coupled to the processing circuit 1006 such that the processing circuit 1006 can read information from, and write information to, the memory device 1008. That is, the memory device 1008 can be coupled to the processing circuit 1006 so that the memory device 1008 may be at least accessible by the processing circuit 1006, including examples where the memory device 1008 may be integral to the processing circuit 1006 and/or examples where the memory device 1008 may be separate from the processing circuit 1006.

Programming stored by the memory device 1008, when executed by the processing circuit 1006, may cause the processing circuit 1006 to perform one or more of the various functions and/or process steps described herein. Thus, according to one or more aspects of the present disclosure, the processing circuit 1006 may be adapted to perform (in conjunction with the memory device 1008) any or all of the processes, functions, steps, and/or routines associated with device 1002 described herein.

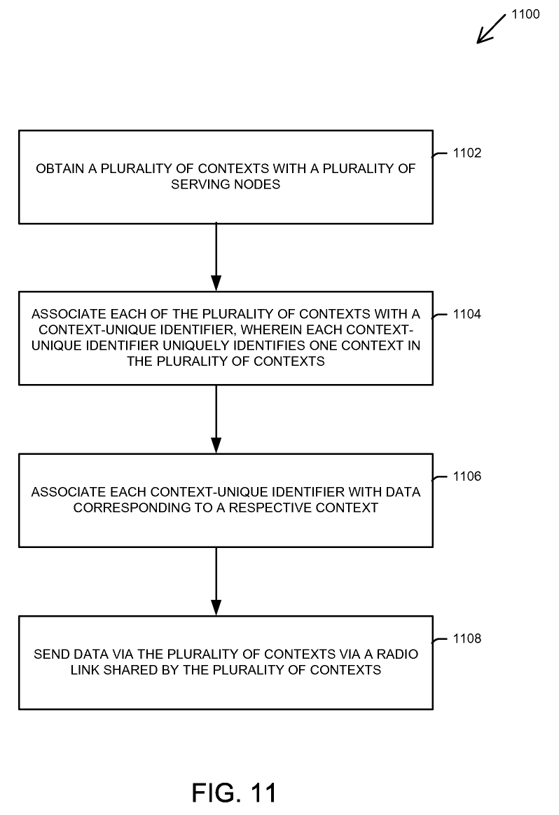

FIG. 11 is a block diagram illustrating an exemplary method supporting multiple concurrent contexts between a device (e.g., a chip component, client device) and a plurality of serving nodes (e.g., MMEs) over the same radio link in accordance with aspects described herein. The method may be operational at a device (e.g. chip component, client device). The device may be split into a plurality of logical instances of itself. Each logical instance of itself may be associated with a unique credential and/or a service. From an outside perspective, the device may appear to be a collection of independent devices. Each of the independent logical instances of the device is associated with a separate context-unique identifier.

The method may include obtaining 1102, at the client device, a plurality of contexts with a plurality of serving nodes (e.g., MMEs). Associating 1104, each of the plurality of contexts with a context-unique identifier (e.g., Virtual-ESM identifier, VESM identifier, VESM tag, where each context-unique identifier may uniquely identify one context in the plurality of contexts. Associating 1106 each context-unique identifier with data corresponding to a respective context. The method may further include sending 1108 the data via the plurality of contexts via a radio link shared by the plurality of contexts.

According to some aspects described herein, the plurality of serving nodes may be comprised of a plurality of logical instances of one or more physical serving node. In addition, each context may correspond to a service (e.g., an application service). For example, each context may correspond to a different service running on the device. Exemplary services include one or more types of traffic, for example, streaming video, voice, and data services. Each context may be associated with a plurality of subscriptions. The device may be associated with a plurality of credentials and each context may be associated with a separate one of the plurality of credentials. In other words, the plurality of contexts may be associated with a plurality of credentials or, there may be a one-to-one relationship between the plurality of contexts and the plurality of credentials. In some aspects, at least one of the plurality of contexts corresponds to a set of subscriber credentials, which is a default set of subscriber credentials.

According to some aspects, the plurality of contexts may be a plurality of non-access stratum (NAS) contexts. The plurality of serving nodes may be a plurality of mobility management entities (MMEs). Each of the plurality of serving nodes (e.g., MMEs) may be independent from each other.

According to some aspects, each context-unique identifier may be derived by the device. According to some aspects, each context-unique identifier may include a portion derived by the device and a portion corresponding to an identifier of the device. The identifier of the device may be, for example, a globally unique temporary identifier (GUTI) provided by an MME to identify one of a plurality of logical instances of the device, a radio network temporary identifier (RNTI) (e.g., a C-RNTI provided by an access node to identify the device as a whole), and/or an identifier allocated by a network to the device related to a location of the device.

According to one aspect, the device may obtain each context-unique identifier from an access node. The access node may have established one or more contexts with the device.

According to some aspects, each context-unique identifier includes a portion derived by an access node and a portion corresponding to an identifier of the device. As indicated above, examples of identifiers of the device include a globally unique temporary identifier (GUTI), a radio network temporary identifier (RNTI), and/or an identifier related to the device location that is allocated by a network to the device.

According to some aspects, the data corresponding to a respective context may be control-plane data (e.g., signaling data). The control-plane data can be NAS data. Alternatively, the data corresponding to a respective context may be user-plane data.

According to some aspects, the data corresponding to a respective context may be encrypted with credentials associated with the context-unique identifier associated with the data. According to some aspects, distinct security contexts are associated with each of the plurality of contexts of the device.

In some aspects, the radio link is served by an access node, shared by the plurality of contexts, and concurrently serves one or more radio resource control (RRC) connections.

In some aspects, the method further comprises multiplexing data associated with the plurality of contexts over the radio link over one RRC connection. In other words, the method may further include multiplexing data associated with the plurality of contexts simultaneously over the shared radio link to send the data to the plurality of serving nodes in a single RRC connection message.

According to some aspects, each of the plurality of contexts can be set to one of a plurality of modes independent of other contexts in the plurality of contexts. Each mode may describe a status of an RRC connection. For example, each of the plurality of contexts can be set to a connected mode or an idle mode independent of other contexts in the plurality of contexts.

According to one aspect, a handover, from a first access node (e.g., eNodeB) to a second access node, transferring, by the device, each of the plurality of contexts that are served by the first access node, transfers only those contexts that are in a connected mode and not in an idle mode from the first access node to the second access node. In other words, the handover, from the first access node (e.g., eNodeB) to the second access node, transferring by the device each of the plurality of contexts that are served by the first access node, transfers only those contexts that are active from the first access node to the second access node.

According to some aspects, the plurality of contexts is associated with a respective plurality of tracking areas within a plurality of cells in a network, wherein a first tracking area associated with a first context is different from a second tracking area associated with a second context.

According to one aspect, a first context may be associated with a first context identifier. The first context identifier may be appended to data to be transmitted from the device, when the data is associated with the first context. The first context identifier may be used to distinguish one context from a plurality of other contexts that may exist at the device. Obtaining the first context may include establishing a connection between the device and an access node over a radio link and may further include establishing an NAS context between the device and a serving node, such as an MME. The radio link may be a radio resource control (RRC) layer radio link of a communication protocol stack.

In one example, the data may be a stream of packets and the first context identifier may be appended to each packet. The first context may correspond to a set of subscriber credentials. The set of subscriber credentials may be a default set of subscriber credentials. The data may be control-plane data (e.g., control signaling) or, according to another aspect, the data may be user-plane data (e.g., user traffic), or according to still another aspect, the data may be control-plane and data-plane data (e.g., control signaling and user traffic). The first context identifier may be generated by the device, according to another aspect, it may be received from an access node. The first context identifier may be received from the access node in response to a request from the device.

In various examples, the device may obtain a second context. The second context may be associated with a second context identifier. The second context identifier may be associated to data to be transmitted from the device, when the data is associated with the second context. This may allow data for the first and second contexts to simultaneously operate over a shared first radio link. Obtaining the first and second context may occur sequentially, or in another aspect, may occur in parallel. The device may store a cross reference between a plurality of context identifiers and a respective plurality of contexts in a memory device of the device. The data for first and second contexts may be simultaneously multiplexed over the shared first radio link for transmission to a plurality of mobility management entities (MMEs).

In various examples, the first context and the second context may each include subscriber credentials that are different from one another. Furthermore, any context may be set to a connected mode or an idle mode independent of any other context. For example, the first context may be set to a connected mode or an idle mode independent of the second context. A handover of the shared first radio link from a source access node to a target access node may transfer the first and/or second contexts when in the connected mode but not in the idle mode. Still further, the first and second contexts may be associated with respective tracking areas within a plurality of cells in a network. The first tracking area may be associated with the first context and may be different from a second tracking area associated with the second context

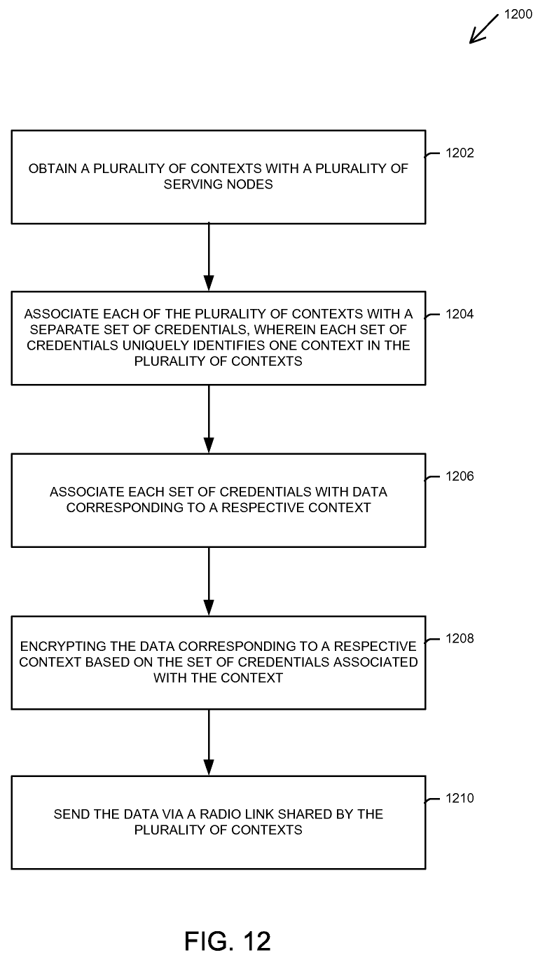

FIG. 12 is a block diagram illustrating an another exemplary method supporting multiple concurrent contexts between a device (e.g., a chip component, client device) and a plurality of serving nodes (e.g., MMEs) over the same radio link in accordance with aspects described herein. The method may be operational at a device (e.g., chip component, client device). The device may be split into a plurality of logical instances of itself. Each logical instance of itself may be associated with a unique credential and/or a service. From an outside perspective, the device may appear to be a collection of independent devices. Each of the independent logical instances of the device is associated with a separate context-unique identifier.

The method may include obtaining 1202, at the client device, a plurality of contexts with a plurality of serving nodes (e.g., MMEs). Associating 1204 each of the plurality of contexts with a separate set of credentials, where each set of credentials may uniquely identify one context in the plurality of contexts. Associating 1206 each set of credentials with data corresponding to a respective context. Encrypting 1208 the data corresponding to a respective context based on the set of credentials associated with the context. The method may further include sending 1210 the data via a radio link shared by the plurality of contexts.

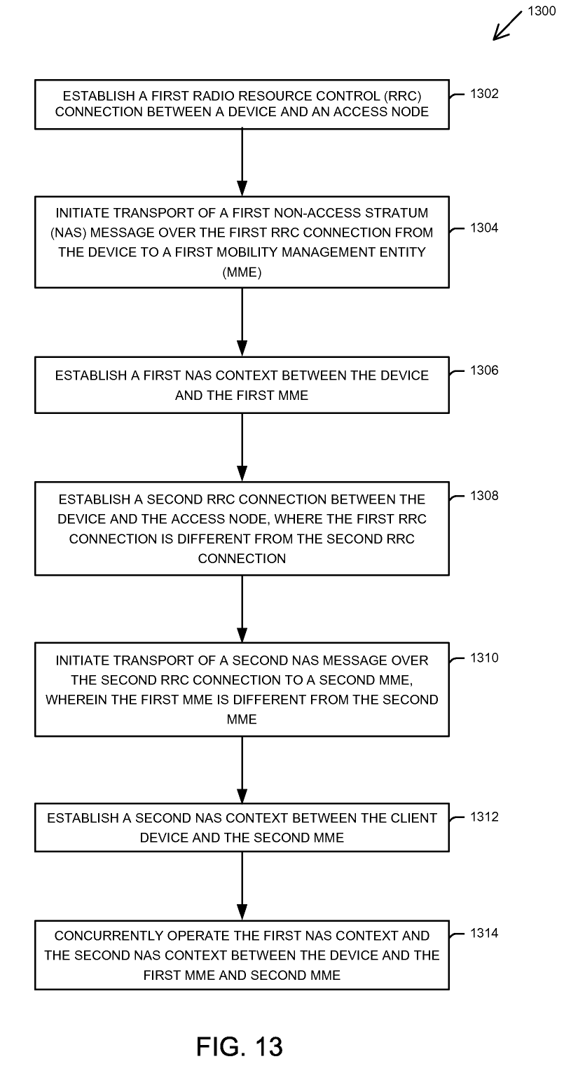

FIG. 13 is a block diagram illustrating an another exemplary method supporting multiple concurrent contexts between a device (e.g., a chip component, client device) and a plurality of serving nodes (e.g., MMEs) over the same radio link in accordance with aspects described herein.

In accordance with the method illustrated by FIG. 13, a device may establish 1302 a first radio resource control (RRC) connection between the device and an access node (e.g., eNodeB) (e.g., establishing, at the device, a first radio resource control (RRC) connection at an access node). The device may initiate 1304 transport of a first non-access stratum (NAS) message over the first RRC connection to a first mobility management entity (MME). A first NAS context may be established 1306 between the client device and the first MME. At the client device, a second RRC connection may be established 1308 (e.g., establishing, at the device, a second RRC connection at the access node). The first RRC connection may be different from the second RRC connection. The device may initiate 1310 transport of a second NAS message over the second RRC connection to a second MME. The first MME may be different from the second MME. A second NAS context may be established 1312 between the device and the second MME. Next the concurrent operation 1314 of the first NAS context and the second NAS context between the device and the first MME and second MME may occur.

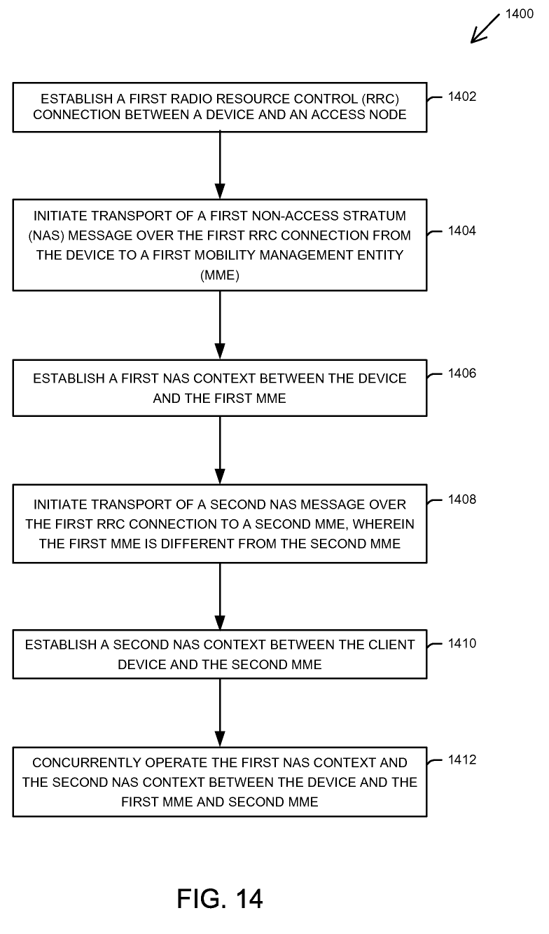

FIG. 14 is a block diagram illustrating still another exemplary method supporting multiple concurrent contexts between a device (e.g., a chip component, client device) and a plurality of serving nodes (e.g., MMEs) over the same radio link in accordance with aspects described herein. The method may be operational at a device (e.g., chip component, client device).

In accordance with FIG. 14, the device may establish 1402 a first radio resource control (RRC) connection between the device and an access node (e.g., eNodeB). The device may initiate 1404 transportation of a first non-access stratum (NAS) message over the first RRC connection to a first mobility management entity (MME). A first NAS context may be established 1406 between the client device and the first MME. The device may initiate 1408 transportation of a second NAS message over the second RRC connection to a second MME. The first MME may be different from the second MME. A second NAS context may be established 1410 between the device and the second MME. Next the concurrent operation 1412 of the first NAS context and the second NAS context between the device and the first MME and second MME may occur.

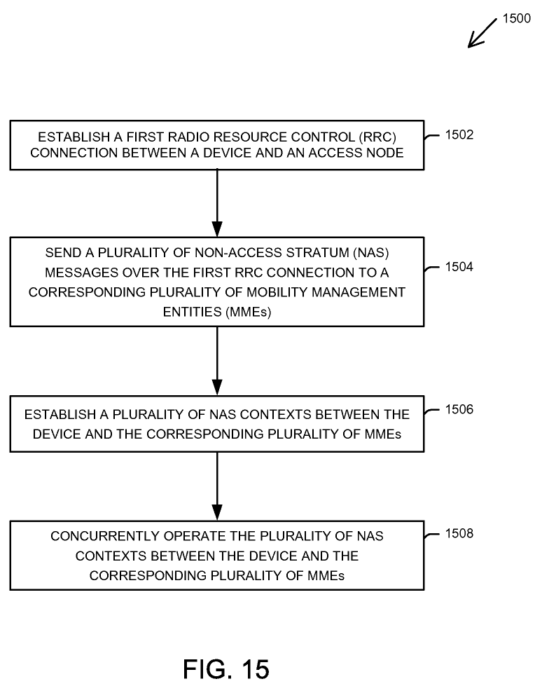

FIG. 15 is a block diagram illustrating still another exemplary method supporting multiple concurrent contexts between a device (e.g., a chip component, client device) and a plurality of serving nodes (e.g., MMEs) over the same radio link in accordance with another aspect described herein. The method may be operational at a device (e.g., chip component, client device).

According to the aspect of FIG. 15, a device may establish 1502 a first radio resource control (RRC) connection between the device and an access node (e.g., eNodeB). The device may send 1504 a plurality of multiplexed non-access stratum (NAS) messages over the first RRC connection to a corresponding plurality of mobility management entities (MMEs). The device may establish 1506 a plurality of NAS contexts between the device and the corresponding plurality of MMEs. Next the concurrent operation 1508 of the plurality of NAS contexts between the device and corresponding plurality of MMEs may occur.

### Exemplary Access Node, Mobility Management Entity, Serving Gateway Device

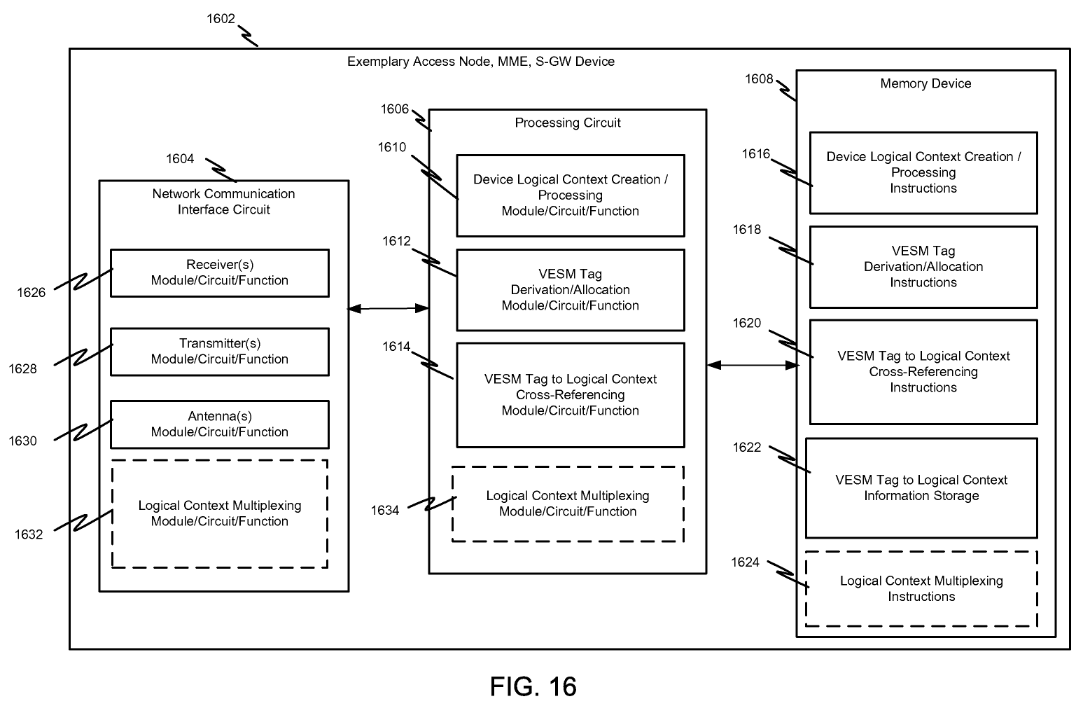

FIG. 16 illustrates a unit representative of an exemplary access node (e.g., eNodeB), MME (e.g., serving node), or S-GW (collectively or individually referred to herein as exemplary unit 1602) configured to support a device operating on a single radio link shared by multiple logical contexts established for the device in accordance with aspects described herein.

The exemplary unit 1602 of FIG. 16 may include one or more of a network communication interface circuit 1604, a processing circuit 1606, and a memory device 1608 that may be operationally coupled to one another.

The network communication interface circuit 1604, may serve to couple the exemplary unit 1602 to one or more networks or wireless devices using one or more wired or wireless access technologies that facilitate establishing a links between devices and serving nodes, access nodes, MMEs, or S-GWs. Accordingly, the network communication interface circuit 1604 may be configured to facilitate wireless communications of the exemplary unit 1602. The network communication interface circuit 1604 may include including at least one receiver module/circuit/function 1626 and/or at least one transmitter module/circuit/function 1628. The network communication interface circuit 1604 may also include one or more antenna modules/circuits/functions 1630 operationally coupled to the at least one receiver module/circuit/function 1626 and/or at least one transmitter module/circuit/function 1628. The antenna(s) 1630 may facilitate wireless communication with the one or more client devices, networks, and/or services. Additionally, a module/circuit/function to implement logical context multiplexing 1632 for data on a Layer 2 radio link of a communication protocol stack or on an RRC layer of the protocol stack may be optionally included in whole or in part in the network communication interface circuit 1004.

The processing circuit 1606 may be operationally coupled to the network communication interface circuit 1604. The processing circuit 1606 may include a device logical context creation/processing module/circuit/function 1610, a VESM tag derivation/allocation module/circuit/function 1612, and/or a VESM tag to logical context cross-referencing module/circuit/function 1614. The module/circuit/function to implement logical context multiplexing 1634 for data on a Layer 2 radio link of a communication protocol stack (e.g., LTE Layer 2, RRC layer) may be optionally included in whole or in part in the processing circuit 1606. The processing circuit 1606 may be arranged to obtain, process, format, and/or send data, control data access and storage, issue commands, and control other desired operations. The processing circuit 1606 may include circuitry adapted to implement desired programming provided by appropriate non-transient media in at least one example. For example, the processing circuit 1606 may be implemented as one or more processors, one or more controllers, and/or other structure configured to execute executable programming. Examples of the processing circuit 1606 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 1606 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 1606 are for illustration and other suitable configurations are within the scope of the present disclosure are also contemplated.

The processing circuit 1606 may be adapted for processing, including the execution of programming, which may be stored on the memory device 1608. As used herein, the term “programming” may be construed broadly to include without limitation instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The memory device 1608 may be operationally coupled to the processing circuit 1606 and may also may be operationally coupled to the network communication interface circuit 1604. The memory device 1608 may include device logical context instructions 1616, VESM tag generation/allocation instructions 1618, VESM tag to logical context cross-referencing instructions 1620, VESM tag to logical context information storage 1622, and/or logical context multiplexing instructions 1624.

The memory device 1608 may include one or more non-transient computer-readable, machine-readable, and/or processor-readable devices for storing programming, such as processor executable code or instructions (e.g., software, firmware), electronic data, databases, or other digital information. The memory device 1608 may also be used for storing data that may be manipulated by the processing circuit 1606 when executing programming. The memory device 1608 may be any available non-transient media that can be accessed by a general purpose or special purpose processor, including portable or fixed storage devices, optical storage devices, and various other non-transient media adapted to store, contain, and/or carry programming. The memory device 1608 may include a non-transient computer-readable, machine-readable, and/or processor-readable storage medium such as a magnetic storage device (e.g., hard disk, floppy disk, magnetic strip), an optical storage device (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and/or other media for non-transient storage of programming, as well as any combination thereof.

The memory device 1608 may be coupled to the processing circuit 1606 such that the processing circuit 1606 can read information from, and write information to, the memory device 1608. That is, the memory device 1608 can be coupled to the processing circuit 1606 so that the memory device 1608 may be at least accessible by the processing circuit 1606, including examples where the memory device 1608 may be integral to the processing circuit 1606 and/or examples where the memory device 1608 may be separate from the processing circuit 1606.

Programming stored by the memory device 1608, when executed by the processing circuit 1606, may cause the processing circuit 1606 to perform one or more of the various functions and/or process steps described herein. Thus, according to one or more aspects of the present disclosure, the processing circuit 1606 may be adapted to perform (in conjunction with the memory device 1608) any or all of the processes, functions, steps, and/or routines associated with exemplary device 1600 described herein.

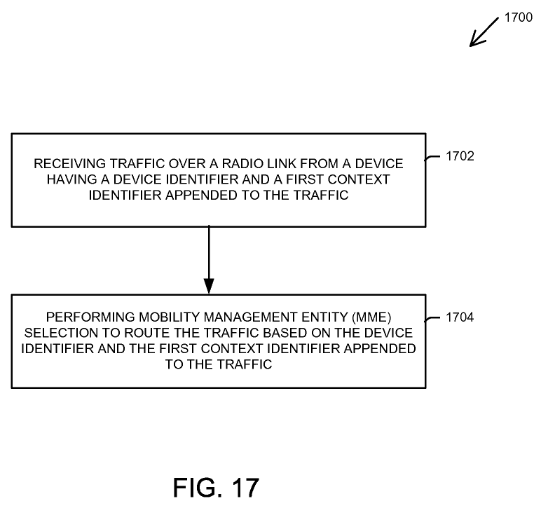

FIG. 17 illustrates a first method 1700 of supporting concurrent contexts for the same device according to aspects described herein. The method may be operational at an access node. The method may include receiving 1702 data over a radio link from a device, wherein a device identifier and a first context identifier are appended to the data. The method may then include performing 1704 mobility management entity (MME) selection to route the data based on the device identifier and the first context identifier appended to the data.

The radio link may be at a radio resource control (RRC) layer of a communication protocol stack. According to some aspects, the data may be a stream of packets; accordingly, the context identifier and the device identifier may be appended to each packet. Performing MME selection based on a second context may occur even if an access node of a radio access network (RAN) is already handling a first context for the device, where the first and second context identifiers are different, MME selection based on the first context identifier may include performing a search for the first context identifier and the device identifier in a table stored at the access node. The table may provide a cross-reference between context identifiers, device identifiers, and MME identifiers. The MME may be selected based on a result of performing the search.

In some aspects, the data may have identical context identifiers, even when the data is received from devices having distinct device identifiers. In such cases, the data may be distinguished from one another by the distinct device identifiers. In one example, the device identifier may be a cell radio network temporary identifier (C-RNTI). The C-RNTI of two devices will be always be different from one another. Thus, even if the context identifiers are identical, the C-RNTIs will be different.

In one implementation, first data associated with a first context of a first device and having a first context identifier is received over a radio link at the access node. Similarly, second data associated with a second context of the same device and having a second context identifier is also received at the access node. The first and second data may be sent or relayed over the same radio link to the access node. According to such an exemplary aspect, the first and second data may be destined for different NAS contexts established for the one device. Distinct security contexts may be associated with each of the NAS contexts. According to one aspect, the first and second data may be forwarded from a packet data convergence protocol (PDCP) entity of a communication protocol stack.

In some implementations, a first set of keys associated with the first data may be received, and a second set of keys associated with the second data may also be received. Integrity protection and ciphering may be applied to the first data using the first set of keys and to the second data using the second set of keys.

According to other aspects, device identifiers may be mapped to context identifiers, context identifiers may be mapped to MME identifiers, context identifiers may be mapped to security contexts, and/or context identifiers may be mapped to serving gateways. One or more of these mappings may be stored in a storage device at the access node.

Additional data may be received over the radio link from the device. The additional data may be from multiple simultaneous contexts multiplexed over the radio link. The additional data may appear to the access node as data from a set of multiple devices, each of the multiple devices associated with a specific subscription credential that may be different from subscription credentials of other devices.

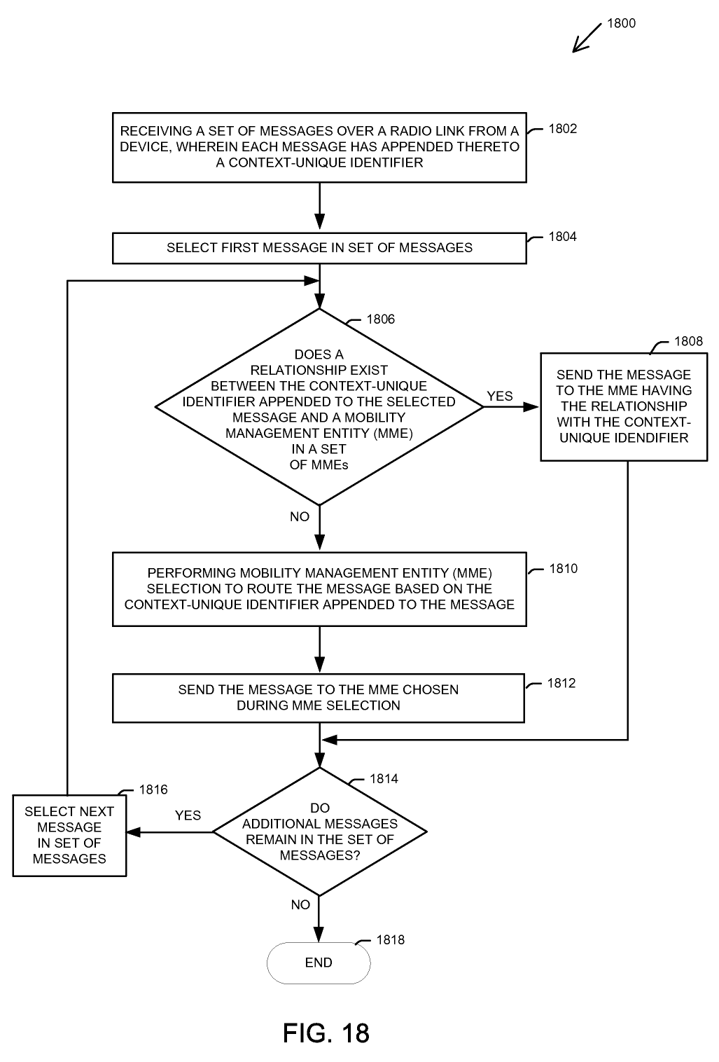

FIG. 18 illustrates a second method of supporting concurrent contexts for the same device according to aspects described herein. The method may be operational at an access node. The method may include receiving 1802 a set of messages over a radio link from a device, wherein a context-unique identifier is appended to each message in the set of messages. The method may include selecting 1804 a first message from the set of messages. The method may next include determining 1806 if a relationship exists between the context-unique identifier appended to the selected message and a mobility management entity (MME) in a set of MMEs. If a relationship exists between the context-unique identifiers of the selected message and an MME, the method may further include sending 1808 the message to the MME having the relationship with the context-unique identifier. If no relationship exists between the context-unique identifier appended to the selected message and an MME, then the method may include performing 1810 MME selection to route the data based on the context-unique identifier appended to the selected message. The method may then continue by sending 1812 the message to the MME chosen during MME selection. After sending the message (from step 1808 or 1812), the method may continue by determining 1814 if additional messages in the set of messages remain. If additional messages in the set of messages remain, then the method may continue by selecting 1816 the next message in the set of messages. Thereafter, the method may return to determining 1806 if a relationship exists between the context-unique identifier appended to the selected message and a mobility management entity (MME) in the set of MMEs. If no messages remain, the method may end 1818.

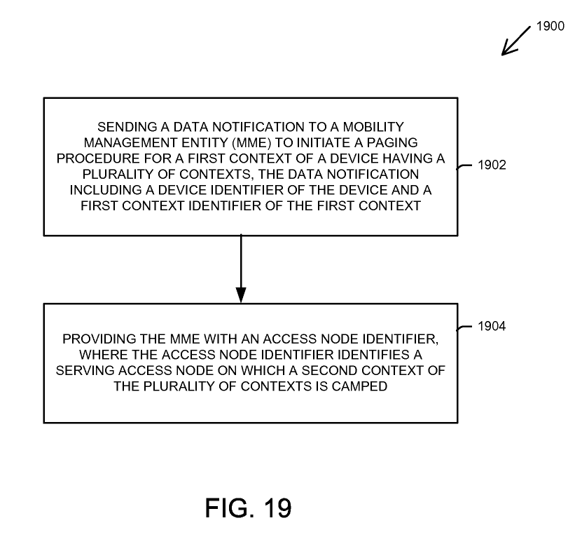

FIG. 19 illustrates another method of supporting concurrent contexts for the same device according to aspects described herein. The method may be operational at a serving gateway. The method operational at a serving gateway includes sending 1902 a data notification to a mobility management entity (MME) to initiate a paging procedure for a first context of a device having a plurality of contexts. The data notification may include a device identifier of the device and a first context identifier of the first context The serving gateway may provide 1904 the MME with an access node identifier, where the access node identifier may identify an access node with which a second context of the plurality of contexts is camped. According to one aspect, the second context may be different from the first context.

In one implementation, the MME is provided with the access node identifier by instructing an access node associated with the device to send the access node identifier to the MME. Alternatively, the MME may be provided with the access node identifier directly from the serving gateway. In one example, the second context may be in an active mode while the first context may simultaneously be in an idle mode. The data notification sent by the serving gateway may be used to trigger the first context identified by the first context identifier to send a service request, including the device identifier and the first context identifier, to the access node over a radio link of a radio access network. According to one aspect, the device identifier may be a globally unique temporary identity (GUTI). The first context may monitor paging channels while in an idle mode even when another context in the plurality of contexts is in an active mode.

One or more of the components, steps, aspects, and/or functions illustrated in the figures may be rearranged and/or combined into a single component, step, aspect, or function or embodied in several components, steps, or functions. Additional elements, components, steps, and/or functions may also be added without departing from novel aspects disclosed herein. The apparatus, devices, and/or components illustrated in the figures may be configured to perform one or more of the methods, aspects, or steps described in the figures. The novel algorithms described herein may also be efficiently implemented in software and/or embedded in hardware.

Also, it is noted that the examples may be described as a process depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices and/or other machine-readable mediums, processor-readable mediums, and/or computer-readable mediums for storing information. The terms “machine-readable medium”, “computer-readable medium”, and/or “processor-readable medium” may include, but are not limited to non-transitory mediums such as portable or fixed storage devices, optical storage devices, and various other mediums capable of storing, containing or carrying instruction(s) and/or data. Thus, the various methods described herein may be fully or partially implemented by instructions and/or data that may be stored in a “machine-readable medium”, “computer-readable medium”, and/or “processor-readable medium” and executed by one or more processors, machines, and/or devices.

Furthermore, examples may be implemented by hardware, software, firmware, middleware, microcode, or any combination thereof. When implemented in software, firmware, middleware, or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both. In the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the examples disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various aspects of the examples described herein can be implemented in different systems without departing from the scope of the disclosure. It should be noted that the foregoing examples are merely examples and are not to be construed as limiting. The description of the examples is intended to be illustrative, and not to limit the scope of the claims. As such, the present teachings can be readily applied to other types of apparatuses and many alternatives, modifications, and variations will be apparent to those skilled in the art.

What is claimed is:

1. A method, operational at a device, comprising:
obtaining, at the device, a plurality of contexts with a plurality of serving nodes;
associating each of the plurality of contexts with a context-unique identifier, wherein each context-unique identifier uniquely identifies one context in the plurality of contexts;
associating each context-unique identifier with data corresponding to a respective context; and
sending the data via the plurality of contexts via a radio link shared by the plurality of contexts.

2. The method of claim 1, wherein the plurality of serving nodes is comprised of a plurality of logical instances of one or more physical serving node.

3. The method of claim 1, wherein each context corresponds to a service.

4. The method of claim 1, wherein each context is associated with a plurality of subscriptions.

5. The method of claim 1, wherein the device is associated with a plurality of credentials and each context is associated with a separate one of the plurality of credentials.

6. The method of claim 1, wherein the plurality of contexts is associated with a plurality of credentials.

7. The method of claim 1, wherein at least one of the plurality of contexts corresponds to a set of subscriber credentials which is a default set of subscriber credentials.

8. The method of claim 1, wherein the plurality of contexts is a plurality of non-access stratum (NAS) contexts.

9. The method of claim 1, wherein the plurality of serving nodes is a plurality of mobility management entities (MMEs).

10. The method of claim 1, wherein the plurality of serving nodes are independent of each other.

11. The method of claim 1, wherein each context-unique identifier is derived by the device.

12. The method of claim 1, wherein each context-unique identifier includes a portion derived by the device and a portion corresponding to an identifier of the device.

13. The method of claim 12, wherein the identifier of the device is one of a globally unique temporary identifier (GUTI), a radio network temporary identifier (RNTI), and/or an identifier allocated by a network to the device related to a location of the device.

14. The method of claim 1, wherein the device obtains each context-unique identifier from an access node.

15. The method of claim 1, wherein each context-unique identifier includes a portion derived by an access node and a portion corresponding to an identifier of the device.

16. The method of claim 15, wherein the identifier of the device is one of a globally unique temporary identifier (GUTI), a radio network temporary identifier (RNTI), and/or an identifier related to the device location that is allocated by a network to the device.

17. The method of claim 1, wherein the data is control-plane data.

18. The method of claim 1, wherein the data is user-plane data.

19. The method of claim 1, wherein the data is encrypted with credentials associated with the context-unique identifier associated with the data.

20. The method of claim 1, wherein distinct security contexts are associated with each of the plurality of contexts.

21. The method of claim 1, wherein the radio link is served by an access node, shared by the plurality of contexts, and concurrently serves one or more radio resource control (RRC) connections.

22. The method of claim 1, further comprising multiplexing data associated with the plurality of contexts over the radio link over one RRC connection.

23. The method of claim 1, wherein each of the plurality of contexts can be set to one of a plurality of modes independent of other contexts in the plurality of contexts.

24. The method of claim 23, wherein each mode describes a status of an RRC connection.

25. The method of claim 1, wherein a handover, from a first access node to a second access node, transferring, by the device, each of the plurality of contexts that are served by the first access node, transfers only those contexts that are in a connected mode and not in an idle mode from the first access node to the second access node.

26. The method of claim 1, wherein the plurality of contexts is associated with a respective plurality of tracking areas within a plurality of cells in a network, wherein a first tracking area associated with a first context is different from a second tracking area associated with a second context.

27. A device, comprising:
a network communication interface circuit configured to communicate over a wireless network; and
a processing circuit coupled to the network communication interface circuit, the processing circuit configured to:
obtain a plurality of contexts with a plurality of serving nodes;
associate each of the plurality of contexts with a context-unique identifier, wherein each context-unique identifier uniquely identifies only one context in the plurality of contexts;
associate each context-unique identifier with data corresponding to a respective context; and
send the data via the plurality of contexts via a radio link shared by the plurality of contexts.

28. A method, operational at a device, comprising:
obtaining, at the device, a plurality of contexts with a plurality of serving nodes;
associating each of the plurality of contexts with a separate set of credentials, wherein each set of credentials uniquely identifies one context in the plurality of contexts;
associating each set of credentials with data corresponding to a respective context;
encrypting the data corresponding to a respective context based on the set of credentials associated with the context; and
sending the data via a radio link shared by the plurality of contexts.

29. A method, operational at a device, comprising:
establishing, at the device, a first radio resource control (RRC) connection at an access node;
initiating transport of a first non-access stratum (NAS) message over the first RRC connection to a first mobility management entity (MME);
establishing a first NAS context between the device and the first MME;
establishing, at the device, a second RRC connection at the access node, where the first RRC connection is different from the second RRC connection;
initiating transport of a second NAS message over the second RRC connection to a second MME, wherein the first MME is different from the second MME;
establishing a second NAS context between the device and the second MME; and
concurrently operating the first NAS context and the second NAS context between the device and the first MME and second MME.

30. A method, operational at a device, comprising:
establishing, at the device, a first radio resource control (RRC) connection at an access node;
initiating transport of a first non-access stratum (NAS) message over the first RRC connection to a first mobility management entity (MME);
establishing a first NAS context between the device and the first MME;
initiating transport of a second NAS message over the first RRC connection to a second MME, wherein the first MME is different from the second MME;
establishing a second NAS context between the device and the second MME; and
concurrently operating the first NAS context and the second NAS context between the device and the first MME and second MME.

31. A method, operational at a device, comprising:
establishing, at the device, a first radio resource control (RRC) connection;
sending a plurality of multiplexed non-access stratum (NAS) messages over the first RRC connection to a corresponding plurality of mobility management entities (MMEs);
establishing a plurality of non-access stratum (NAS) contexts between the device and the plurality of MMEs; and
concurrently operating the plurality of NAS contexts between the device and the plurality of MMEs.

32. A method operational at an access node, comprising:
receiving data over a radio link shared by a plurality of contexts from a device, the data associated with a first context-unique identifier, the first context-unique identifier uniquely identifying only one context in the plurality of contexts; and
performing mobility management entity (MME) selection to route the data based on the first context-unique identifier.

33. The method of claim 32, wherein the plurality of contexts is a plurality of non-access stratum (NAS) contexts.

34. The method of claim 32, wherein the radio link shared by the plurality of contexts concurrently serves one or more radio resource control (RRC) connections.

35. The method of claim 32, wherein performing MME selection occurs even if a radio access network (RAN) is already handling a context associated with the device and identified by a second context-unique identifier, where the first and second context-unique identifiers are different.

36. The method of claim 32, wherein performing mobility management entity (MME) selection based on the first context-unique identifier includes:
performing a search for the first context-unique identifier in a table stored at the access node, wherein the table provides a cross-reference between context-unique identifiers and MME identifiers; and
selecting an MME based on a result of performing the search.

37. The method of claim 36, further comprising sending the data to the MME.

38. The method of claim 32, further comprising:
receiving first data associated with a first context and the first context-unique identifier over the radio link; and
receiving second data associated with a second context and a second context-unique identifier over the radio link,
wherein the first data and the second data are destined for different contexts established for the device, and the different contexts established for the device operate concurrently.

39. The method of claim 38, wherein distinct security contexts are associated with the first context and the second context.

40. The method of claim 38, wherein the first data and the second data are forwarded from a packet data convergence protocol (PDCP) entity of a communication protocol stack.

41. The method of claim 38, wherein the first data and the second data are multiplexed on one RRC connection via the radio link.

42. The method of claim 38 further comprising:
receiving a first set of keys associated with the first data;
receiving a second set of keys associated with the second data; and
implementing integrity protection and ciphering on the first data using the first set of keys and on the second data using the second set of keys.

43. The method of claim 32, further comprising:
mapping device identifiers to context identifiers;
mapping con text identifiers MME identifiers;
mapping context identifiers to security contexts;
mapping context identifiers to serving gateways; and
storing mapping results in a memory device at the access node.

44. The method of claim 32, further comprising:
receiving additional data over the radio link from the device,
wherein the additional data is associated with multiple concurrent contexts multiplexed together on one RRC connection over the radio link, and the additional data appears to the access node as data from a set of devices, each of the set of devices associated with a specific subscription credential that is different from subscription credentials of other devices.

45. An access node, comprising:
a network communication interface circuit configured to communicate with devices over a wireless network;
a processing circuit coupled to the network communication interface circuit, the processing circuit configured to:
receive data over a radio link shared by a plurality of contexts from a device, the data associated with a first context-unique identifier, the first context-unique identifier uniquely identifying only one context in the plurality of contexts; and
perform mobility management entity (MME) selection to route the data based on the first context-unique identifier.

46. A method operational at a serving gateway, comprising:
sending a data notification to a mobility management entity (MME) to initiate a paging procedure for a first context of a device having a plurality of contexts, the data notification including a device identifier of the device and a first context identifier of the first context; and
providing the MME with an access node identifier, where the access node identifier identifies an access node on which a second context of the plurality of contexts is camped.

47. The method of claim 46, wherein providing the MME with the access node identifier includes instructing an access node associated with the device to send the access node identifier to the MME.

48. The method of claim 46, wherein providing the MME with the access node identifier includes sending the access node identifier to the MME directly from the serving gateway.

49. The method of claim 46, wherein the second context is different from the first context.

50. The method of claim 46, wherein the second context is in an active mode while the first context is simultaneously in an idle mode.

51. The method of claim 46, wherein the data notification sent by the serving gateway is used to trigger the first context identified by the first context identifier to send a service request, including the device identifier and the first context identifier, to the access node over a radio link of a radio access network.

52. The method of claim 51, wherein the device identifier is a globally unique temporary UE identity (GUTI).

53. The method of claim 46, wherein the first context monitors paging channels while in an idle mode even when another context in the plurality of contexts is in an active mode.

54. A serving gateway, comprising:
a network communication interface;
a processing circuit coupled to the network communication interface, the processing circuit configured to:
send a data notification to a mobility management entity (MME) to initiate a paging procedure for a first context of a device having a plurality of contexts, the data notification including a device identifier of the device and a first context identifier of the first context; and
provide the MME with an access node identifier, where the access node identifier identifies an access node on which a second context of the plurality of contexts is camped.
